(19) United States
(12) Patent Application Publication
(10) Pub. No.: US 2007/0042332 A1
(43) Pub. Date: Feb. 22, 2007

(54) System and method for providing customized contents

(76) Inventor: Young-Hie Leem, Seoul (KR)

Correspondence Address: YOUNG-HIE LEEM, 1018-23, SADANG-DONG, DONGJAK-GU, SEOUL, 156-091, KR

(21) Appl. No.: 11/345,012

(22) Filed: Feb. 2, 2006

Related U.S. Application Data
(63) Continuation-in-part of application No. 10/276,911, filed on May 14, 2003, now Pat. No. 7,044,741.

(30) Foreign Application Priority Data
May 20, 2000 (KR) 2000-27304

(51) Int. Cl. G09B 19/00

(52) U.S. Cl. 434/156

(57) ABSTRACT

The present invention provides a digital voice book library system which through Internet provides an customized digital audio version book that can be customized according to a learner's learning language, learning level, learning condition, learning taste or the like by a learner's selecting/varying audio attributes of the audio version book(digital audio file) associated with the equivalent printed script (hardcopy) version book that is owned by the learner or is borrowed from a conventional library or a book rental store. Wherein the audio attribute of said customized digital audio version book can be varied and customized in language, voice, speech speed or playback device at every repetition time according to user's learning language, learning level, learning condition or the like, corresponding to the equivalent script book despite different audio attribute. Using the present invention a learner can repeatedly listen to a same content audio version book without boring, therefore can acquire a good language ability in short time.

### CROSS-REFERENCE TO RELATED APPLICATIONS

This application claims the benefit of priority of U.S. patent application Ser. No. 10/276,911 which has the filing date of Nov. 20, 2002 and the benefit of priority of the national phase under 35 U.S.C 371 of P.C.T. International Application No. PCT/KR01/00829 which has the International filing date of May 19, 2001, and which also claims the priority of Korean Patent Application No. 2000-27304, filed May 20, 2000, the entire disclosures of each of the above applications are hereby incorporated by reference.

### BACKGROUND OF THE INVENTION

1. Technical Field

The present invention relates to system and method for providing digital audio data useful to learning a language or music over Internet. More particularly, the present invention is related to a system and method in which a script is recorded into language-learning or musical learning digital audio files having different language, voice, and speed attributes and stored on a server with the corresponding script files in various languages having equivalent meaning to each other. The audio files and script files are executed on a user's terminal which may or may not be networked. Therefore the user may be provided with digital contents from the server over the Internet tailored to the user's language, educational level, taste or the like.

2. Description of the Related Art

In a conventional method of learning a language, language-learning contents is provided to a user with a single voice and speaking rate corresponding to one script. The speaking rate of such methods is typically at a normal rate used by native language speakers. Therefore, although a person can use a computer equipped with a repeat playback function and internet for language-learning, such a user may not easily comprehend a foreign language using the conventional audio contents provided with the same voice attribute. Moreover users may be easily bored with repeatedly listening to audio contents having the same voice attribute. In real world situations such as when a person meets foreign native speakers in business, the natives may have different kinds of voices, accents and pronunciations. Accordingly, it is more effective to practice listening to other voice at each repetition so as to be familiar with such voices. However, the conventional foreign language-learning materials do not provide such functionality. When conventional technology is used for providing audio contents for business related application, the personal characteristics of users is not considered resulting in static and inflexible contents.

In order to provide language-learning contents customized for user, the contents needs to be made and provided with the same script but in a manner that takes into consideration each user's learning condition and preferences. It is also necessary to provide various types of contents to a user in a customized manner that is transmitted in real time at any place and time selected by the user. The off-line manufacturing of various contents tends to result in an economic loss being expense and creating little income, when factors such as cost, time, distance, and the like are taken into consideration.

There are many web sites that provide contents for learning foreign language through conventional technology. However, such web sites typically provide contents that has already distributed through various media such as audiotape or CD. Therefore, such web sites do not provide customized contents suitable for each learner.

There is also another prior technology that regulates voice playback speed while playing foreign language-learning contents with an audio player. However, this technology requires installation of a program or mounting a module on a user's terminal thereby adding additional costs. Since the contents is specific to this technology and not in a unified standard file format, additional costs are incurred for manufacturing digital contents. Therefore, this prior art technology has limitations in mass production, distribution and use of customized contents. In addition, since this technology modulates speech rate by means of a program during playback, deterioration of the sound quality is inevitable. Moreover, the user continuously listen to the same voice at each repetition, making the user feel bored while not creating the usual conversation environment.

Accordingly, there exists a need for an improved audio contents-providing system that enables a service provider to provide various kinds of contents at lower cost while allowing a user to access customized contents for language-learning.

### BRIEF SUMMARY OF THE INVENTION

The present invention solves the problems of the prior art by providing a customized contents-providing system. The contents-providing system of the invention includes a method and a medium storing a program executing the method which provides customer-oriented dynamic contents-providing technology for learning a foreign language or music. Moreover, the invention allows the user to configure learning contents in a manner suitable to the user's level, conditions, and the like. Accordingly, individuals may learn foreign languages easily, at lower cost, in a pleasant and convenient way.

A first object of the present invention is to provide a technique, in which speech rate is adjusted while providing the original sound of the contents without installation of a program or device on the user's terminal for adjustment of the speech rate of a digital audio contents.

A second object of the present invention is to provide a technique for customizing digital audio contents corresponding to a script to be recorded for language-learning or musical learning according to user's request. The digital audio contents will have various selectable voice attributes, playback speed attributes, and/or methods of playback, to be suitable for level and conditions of a user (learner).

A third object of the present invention is to provide customized digital audio contents in one or more languages through an interface (e.g. homepage), corresponding in meaning to the same script to be recorded for language-learning or musical learning in a way set forth above for the second object.

A fourth object of the present invention is to make audio contents at a lower cost so that many kinds of digital audio contents having various selectable attributes can be made to be provided with the corresponding scripts having the same meaning but different languages in a customized way like the second technical object.

A fifth object of the present invention is to provide practical examples of using the present invention in various commercial fields.

To achieve the above objects, one embodiment of the invention provides a system for providing customized contents for language-learning or musical learning, based on a client-server communication network. The system of this embodiment comprises:

a means for producing a plurality of the audio contents files each having selectable different attributes by recording a script like a printed script book into one or more digital audio signals that are classified by its attribute;

a WEB/DB linking module which receives user selection information for the audio contents file attribute through the contents-providing means, and retrieves the audio contents files in an on-line or off-line playable format with the attribute corresponding to the user's selection from the contents DB to thereby link to the contents-providing means;

a DB server (“DBMS”) for searching and retrieving the requested data from the contents DB; and

at least one contents-providing server having a contents DB storing the selectable digital audio files with the corresponding script files so that the digital audio files and the script file are linked to each other, and providing the audio contents file and/or corresponding script file with specific attribute requested by a logged-on user through a contents-providing means.

The contents DB comprising digital contents for language learning or musical learning, each contents comprising a plurality of digital audio files each associated with an equivalent script file, the plurality of digital audio files being characterized by one or more audio attributes such that each audio file of the plurality of audio files differ in at least one audio attribute from other digital audio files associated with the equivalent script file, the digital audio files and script files being linked to each other wherein the audio attributes include a playback device attribute and at least one attribute selected from the group consisting of a musical performance type attribute, a language attribute, a voice attribute, and a playback speed attribute.

The contents-providing means comprising a GUI-based display file or text-based display file having contents menu and an audio attribute selection means that includes a component selected from the group consisting of a language attribute selection means, a voice attribute selection means, a playback speed attribute selection means, a musical performance type attribute selection means and a playback device attribute selection means.

In another embodiment of the present invention, a method of providing customized contents for language-learning or musical learning, based on a client-server communication network is provided. The method of this embodiment comprises the steps of:

(a) producing a plurality of audio contents files having selectable different attributes by recording a script into one or more digital audio signals, wherein for a given script different audio contents having selectable different attributes regarding language, voice and speed of speech;

(b) building a contents DB storing the selectable different digital audio files corresponding to a same meaning script to be played in an on-line environment through the communication network and/or in an off-line environment after downloading through the communication network, and the corresponding script files to be linked to each other by the contents-providing means;

(c) providing a user terminal with user selectable contents menu information having an audio attribute selection means for the contents;

(d) receiving user selected audio file attribute information through the user terminal; and

(e) retrieving an audio file or a script file corresponding to the selected audio file attribute information from the contents DB, and providing the retrieved audio file or script file to the user terminal.

Another embodiment of the present invention is related to a system and method for providing practical examples of using the present invention in book publishing field and in book rental field for achieving the 5^{th} object wherein:

a method for providing customized contents with a system comprising a contents DB, a user DB, a book bibliography DB, a book serial number DB and a user owned book DB connected to a wired or wireless communication network,

the contents DB comprising digital contents for language learning or musical learning, each contents comprising:

a plurality of digital audio files each associated with an equivalent script file, the plurality of digital audio files being characterized by one or more audio attributes such that each audio file of the plurality of audio files differ in at least one audio attribute from other digital audio files associated with the equivalent script files, the digital audio files and the script files being linked to each other wherein the audio attributes include a playback device attribute and at least one attribute selected from the group consisting of a musical performance type attribute, a language attribute, a voice attribute and a playback speed attribute;

the user DB comprising information to identify a user;

the book bibliography DB comprising bibliography information of script version book of digital audio version and used for menu information for the audio version of script version book;

the book serial number DB comprising book identification numbers each allocated to a script book respectively for identification for providing its digital audio version;

the user owned book DB comprising information to identify an owner or a user of each script book for providing digital audio version of the script version book in a customized way; and

the method comprising:

(a) receiving an information for identifying a user of a script book from a user;

(b) identifying the user of specific script book;

(c) providing the identified user with contents menu information for audio version of the script book having an audio file attribute selection means for the audio version;

(d) receiving selected information for audio file or script file and its attribute of the audio version from the identified user;

(e) retrieving the audio file or script file corresponding to the selected audio file attribute information from the contents DB; and

(f) providing the retrieved audio file or script file to the user via online or offline.

The contents-providing means preferably comprises GUI (Graphic User Interface)-based contents-providing display file (homepage) or text-based contents-providing display file. The contents-providing server comprises GUI-based server or text-based server. The contents providing display file encompasses the entire display file to be provided via wired or wireless Internet. The audio contents producing means includes the scripts to be recorded and an apparatus for recording the scripts into digital audio signals. The contents-providing means includes a customized homepage to provide a specific customized contents to which the user has recently accessed.

In another embodiment of the present invention, a method for obtaining a large amount of audio contents at low cost is provided.

In one variation of this embodiment, the method comprises the steps of:

providing users with a user-produced contents registering means through the web site;

producing audio contents files requested by the web site, the audio contents files being produced by the users;

uploading the audio contents files produced by the user with an uploading means on the web site;

registering received audio contents files in the corresponding contents DB by the administrator of the web site; and

linking the received audio contents files to the corresponding contents-providing display file by the administrator of the website.

In another variation of this embodiment, the method comprises the steps of:

preparing a main site;

assembling local companies located in various countries, each local company building a local branch site using the present invention and building a version of a contents DB in their respective native languages, each version corresponding to the meaning of the contents of an English version built by the main site; and

providing a user with contents in various languages by linking to user selection means in each local web site.

In another embodiment of the present invention, a method to be used in the music field is provided. The method of this embodiment comprises the steps of:

building a music contents DB consisting of a plurality of music document files (which includes files of musical notes and song words) in various languages, the meanings of whose song words are equal to each other; and a plurality of corresponding music audio files including chant files to be played in an on-line or off-line mode, the music audio files being produced by recording different performances of the music document files by many prayers and various performance means such as musical instruments or voices according to music tune type such as soprano, alto, bass, chant, orchestra, chorus and the like;

linking the music contents DB to a music contents-providing display file; and

providing users with the customized music contents through the music contents-providing display file.

### BRIEF DESCRIPTION OF THE DRAWINGS

FIG. 1a shows a configuration of a contents-providing system according to an embodiment of the present invention;

FIG. 1b shows an example of a contents-providing web page provided by a web site in accordance to the present invention;

FIG. 2 is a flowchart illustrating the process of making a contents-providing web page and contents therein;

FIG. 3 illustrates a preferred embodiment for building a contents DB linked to a contents-providing web page, and for illustrating data attributes;

FIG. 4 illustrates the process of dynamically producing a contents providing web page;

FIG. 5 is a flowchart illustrating the process of a user using provided contents in the present invention;

FIG. 6a illustrates a specific use of the present invention in language learning;

FIG. 6b illustrates a specific use of the present invention in music learning;

FIG. 7 illustrates the method to produce customized contents through contents provider (CP) located in many countries as an practical example of audio contents producing means 4a illustrated in FIG. 1a;

FIG. 8 illustrates the method to produce and provide customized contents through local branch servers located in many countries;

FIGS. 9-13 illustrate the method to produce customized audio contents through publishing companies located in many countries as an another practical example of audio contents producing means 4a illustrated in FIG. 1a;

FIG. 14 illustrates the method to provide customized contents through local branch servers located in many countries;

FIGS. 15-18 illustrate the method to provide contents in connection with book rental agencies; and

FIG. 19 illustrates a system using many practical examples of the present invention.

### DETAILED DESCRIPTION OF THE PREFERRED EMBODIMENT

The objects and characteristics of the present invention will be more easily understood with reference to the accompanying drawings and detailed description below.

Each term used in this specification is specially selected for the convenience of explanation. Therefore, the terms in this specification should be interpreted considering their substantial functions.

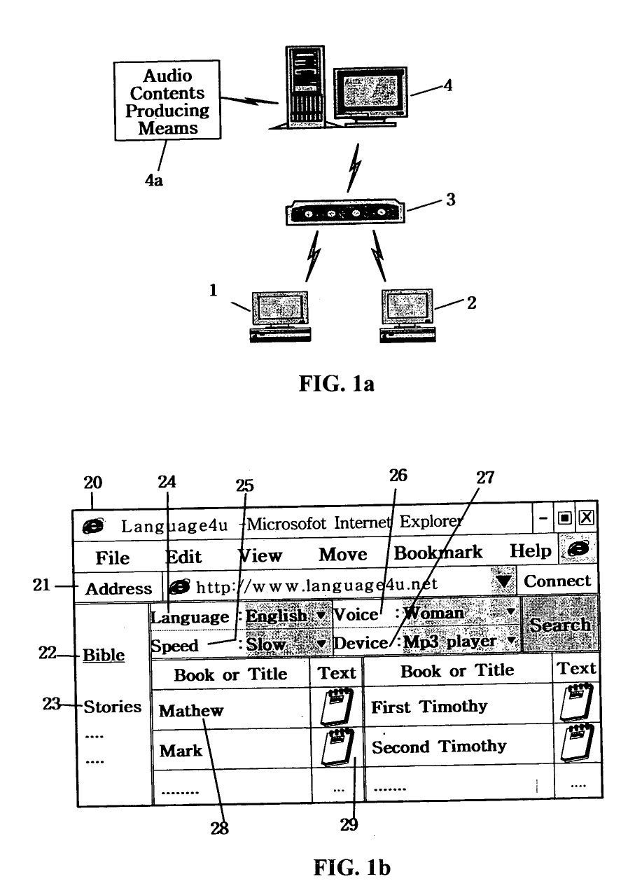

FIG. 1a shows a configuration of a contents providing system according to an embodiment of the present invention. The contents-providing system of this embodiment comprises at least one contents-providing server 4 for providing audio contents, an audio contents producing means (unit) 4a, user terminals 1 and 2 to receive the contents, and a communication network 3 to connect the server and the user terminals for exchange of the data.

Preferably, the contents-providing server 4 comprises the following hardware—a computer server, network equipments, and a high rate Internet connection, and a server operating system (“OS”) such as UNIX and NT, a communication protocol (TCP/IP), a web server program (such as IIS), a database (“DB”) server program (a DBMS such as oracle), a streaming server program for providing streaming-type contents, and a script computer language program such as ASP and PHP supporting interaction of web and DB.

The terminal is provided with a means for retrieving contents information from the server through the wired/wireless communication network, transferring control information required for the server, and a means for playing the contents received from the server either in an on-line or off-line manner, i.e., browser, Real Audio, Window Media Player, Win Amp or the like, and a communication means that includes network equipment and a communication program. Wireless communication terminals such as a PCS phone, a cellular phone, a PDA, a smart phone and IMT-2000, etc., an Internet TV, an Internet set-top box as well as computers may be adopted as the terminals.

The communication network includes wired or wireless computer communication networks. The wireless user terminals 1 and 2 communicate with the server through a gateway unit (not shown) such as WAP (Wireless Application Protocol) server, etc. The audio contents-producing means (unit) 4a includes various kinds of learning materials (scripts) to be recorded, and an apparatus for recording the scripts into audio signals such as recorder and the like. For convenience, FIG. 1a shows only one sever performing all the functions for providing contents. It will be understood for those skilled in the art, that the server may consist of a plurality of servers including an interface server (a web server), a contents (file) server, a DB server, a streaming server, a searching engine server, and the like, in accordance with a function performed by each server. A control module pro1 and a DB server pro2 are integrally combined into the server 4 in FIG. 4, however, it is understood for those skilled in the art, that they may be distributed by at least two computers in an actual case.

Functional configuration elements of the present invention are mainly claimed as ‘steps’ or ‘modules’ in method or program, and as ‘modules’ or ‘means’ in system.

The server executes a method of the present invention by computer programs. The computer programs stored in a computer storage medium (not shown) are called by a server's CPU (not shown), and uploaded into a main memory, RAM (not shown), of the sever to be executed. A homepage as illustrated in FIG. 4 links the control module pro1 and the contents DB.

The storage medium includes a computer-readable storage medium such as ROM, RAM, a CD-ROM, magnetic tapes, a hard disk, floppy disks, and optical data storage devices, and a means implemented in the form of carrier waves, for example, transmission via Internet. Moreover, the computer programs which are in computer-readable codes may be distributed and stored in several computer systems which are connected with one another through a network.

Specifically, the computer program is encoded by a hypertext mark-up language such as XML and HTML, and a script language such as JAVA, ASP, PHP and PEAL. However, the computer program may be embodied by various languages supported by the operation system, the server and the user terminal, as well as, state of the art programming. Preferably, the computer program and the contents may be adopted to support wireless communication with wireless user terminals.

Server administrators build and administer the web site, contents DB, and user DB. Moreover, the operation of the administrators is deemed to be included in the function of the server so that explanation thereof will be omitted hereinafter.

FIG. 1b illustrates an example of the configuration of display file for providing the contents according to the present invention. When a user connects with a web server by filling the address of a web server in an address input box 21 of a web browser 20 and transmitting the same via Internet 3, a homepage including a menu page of the contents DB and corresponding contents-providing display file(web page) 20-1 is downloaded, and displayed on a monitor of the user computer 1 as shown in FIG. 1b.

The user may be provided with specific contents by choosing the desired contents-providing display file in the above contents DB menu home pages that are classified according to categories. As shown in FIG. 1b, the contents DB menu page in which the contents DB menu icons 22 and 23 are aligned are displayed on the left frame in the web browser of the user computer. The contents-providing display file 20-1 corresponding to the selected icon of the contents DB menu are on the right frame. Various configuration of the menu pages may be used such as a category-type with or without a key word searching means. User selection means 24 through 27 are located at the upper part of the contents-providing display file. A plurality of contents buttons 28 indicating contents titles and script buttons 29 are located at the lower part of the contents-providing display file. The contents buttons 28 are linked to audio contents files provided by the user making attribute selections 24 through 27. The audio contents files have selectable different voices, different speech rates, and/or different playable formats corresponding to the same script. Additional details regarding FIG. 1b are set forth below.

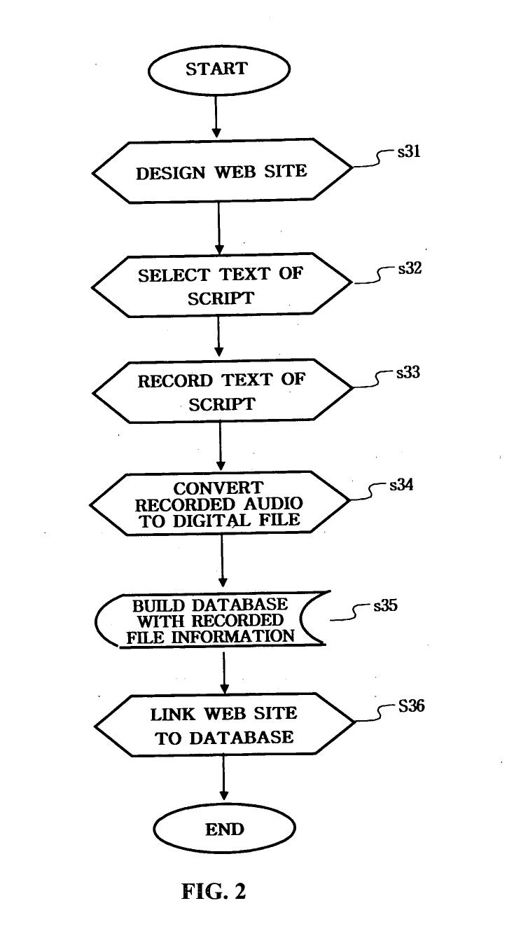

FIG. 2 is a flowchart for illustrating a process of making the contents providing display file and contents provided through the display file. First, a plurality of the contents-providing display file functioning as contents-providing means are designed (step S31). Preferably, the contents-providing display file is dynamically generated by the server with a WEB/DB linking module in a hypertext language such as HTML and a script language such as ASP, depending on the user's preference. The dynamical contents-providing display file may be produced by linking URLs of the contents files selected by user attribute selection means 24 through 27 to predetermined contents title buttons 28 and 29 of a predetermined contents-providing display file form (template pages), Alternatively, contents file information corresponding to the user attribute selection means 24 through 27 is retrieved along with index information of the retrieved information (such as the titles of contents, etc.) being provided as a contents selection means linked to URL through the board type display file. Other type of contents-providing display file may be easily made using the technology described herein combined with well-known WEB/DB linking technology.

Alternatively, a plurality of static display files (not shown) having a plurality of predetermined contents selection means (icons) linked to the URLs of contents files are prepared and stored in the storage device while being classified by category. The static display file may then be searched and provided through a separate search page according to the user's selection. Specifically, the search page may allow a search of the desired contents-providing display file in a hierarchy based on subject words classified by category as done, for example, by Yahoo (www.yahoo.com). Furthermore, the search page may include key word searching that provides a plurality of contents-providing display file information resulting from a key word search, and desired display file upon user's selection as in Yahoo. In addition, in the case of a server providing text-based contents, the server naturally provides a text-based menu (display) file (not shown).

Learning materials (scripts) to be recorded are transformed into digital contents that are provided through the web site (step S32). The scripts can be any types of material useful to language-learning or musical learning, including the Bible, novels, fairy tales, words of a song, musical notes, poem and chant scripts. Preferably, the scripts may be selected not to infringe any copyright.

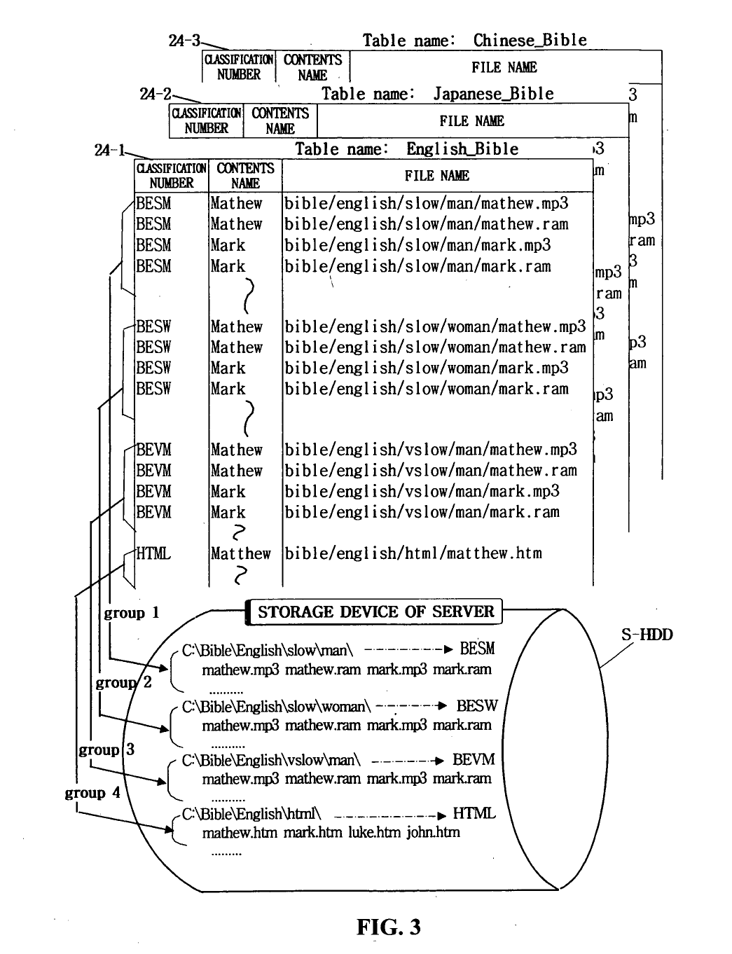

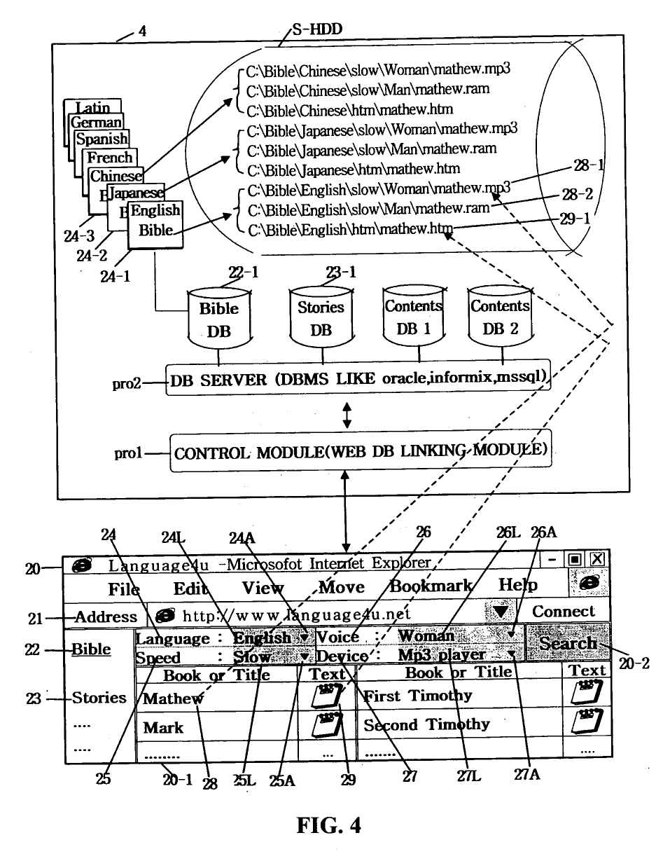

The chosen scripts are then recorded (step S33) by several persons, i.e., a man, a woman and children, etc., having different voices at different speech rates, i.e., normal, slow and very slow, etc., in different languages, i.e., English, Japanese and Chinese, etc. Preferably, the recordings are made by native speakers. The script is recorded in such a manner to allow playback and editing by computers or recording devices (an audio contents producing means). Next, if the contents is analogue type audio contents, the recorded audio contents is converted into a digital audio contents file and encoded into various digital file formats such as REAL AUDIO files (RAM, RA) and MP3 files in order to be played by on-line playing means (Real Audio, etc.) or off-line playing means (Real audio, WinAmp, MP3 players, etc.). In doing so, the audio contents files are classified for the contents DB as in FIG. 3 and the contents-providing display file, and stored in server's storage device (medium) (step S34).

The file information of the stored contents which is classified and labeled as in FIG. 3, is build into a database as shown in FIGS. 3 and 4 for enabling convenient searching and administration of the contents files (step S35). The file information is used by control module pro1 and DB server pro2 to search the contents file URL information.

The URL information of the contents file produced by the above procedure is then linked to the contents providing display file designed in step S31, so that when the user clicks on a desired contents button 28 of the display file, corresponding contents file is played during streaming or downloaded in the user terminal (step S36).

In step S34, conventional technologies are used for the conversion of audio files to be played on-line (RAM, RA, etc.) or off-line (MP3 files, etc.). An example of the embodiment of the conventional technologies is as followings. The audio contents files produced in step S33 are changed into WINDOW wave files (*.WAV) using a conversion program as available from the sound-card manufacturing companies, etc. or conventional multimedia producing tools, and then encoded, e.g., into Real audio files by Real Producer of Real Network company (www.realnetworks.com) and into MP3 files by various kinds of MP3 encoder programs (such as MP3 Enc 3.1, etc.). Alternatively, the script may be recorded directly into the digital audio files such as Real Audio files by special recording devices. In this case, the digital audio contents files are edited to be suitable for the contents-providing display file of the step S31 and then stored in the storage device in the server as in the step S34.

Display file to be used for contents-providing means are designed in step S31. In steps S32 and S33 audio contents is produced by audio contents producing means (unit) 4a. A digital audio contents DB to provide the produced audio contents through the display file is built in S34 and S35. In step S36, executable contents-providing display file is produced by linking the URL of the digital audio contents to the designed contents-providing display file. Although, step S31 may be implemented after the step S35, preferably it occurs priors to step S35.

FIG. 3 shows a preferable embodiment of the method of building a contents DB with an attribute table used for the contents providing display file of FIG. 1b. However, the present invention is not limited to the embodiment of FIG. 3 with various modifications depending on the searching method of control module pro1.

With reference to FIG. 3, Bible contents DB includes the URL information tables linked to the script files and the digital audio files in at least English, Japanese and Chinese. The server's storage device (S-HDD) stores the digital audio files corresponding to the URL information. In this embodiment, three language versions of digital audio files can be provided, each having different attributes with respect to the script for each language (each version of the scripts for a given language has the same meaning). Each language version of the digital audio files can be easily retrieved in the same attribute group using a classification number. Directories of the server storage device (S-HDD) in which the digital audio files are stored are named corresponding to the classification number of the table.

Although in the example of FIG. 3, only RAM files and MP3 files are shown as the on-line and off-line playable files, any type of on or off-line playable files can be adopted in the present invention as is understood by those skilled in the art.

Reference numerals 24-1, 24-2 and 24-3 represent tables of the Bible DB. An English_bible table with the field attributes and the information stored in records is shown according to the user's selecting English in the language selection means 24 of FIG. 1b. In each record of the English_Bible tables, the URL (Uniformed Resource Locator) information is presented as ‘file name’ indicating the precise location of special contents file in the server storage device (S-HDD). Classification numbers are also present in each record as an identifier of the record. The ‘classification number’ of FIG. 3 consists of alphabet initials of the name of contents DB, the name of language table, the speech rate, and the kind of voice, etc., thereby enabling a rapid and accurate retrieval of record group having the same attribute upon selection of user attribute selection means 24 to 27. This also allows dynamical linking the URL corresponding to digital audio contents file to the contents button 28 of the contents-providing display file. The script file (see 29-1 in FIG. 4) is labeled ‘HTML’ since this file is in the HTML format. Alternatively, the script file may be in another format that is useful when the user terminals are wireless devices. The ‘contents name’ is given the name attribute of contents button 28 of the contents-providing display file for conveniently and dynamically linking to contents button 28 by the WEB/DB module. The ‘file name’ indicates the URL of contents file in the server storage device (S-HDD) so that the file name is dynamically linked according to ‘contents name’ with the contents button 28 of the Bible contents-providing display file in FIG. 4. A ‘RA’ file streamed during playing is stored in the same directory where RAM files are typically stored when sent to the user terminal by streaming program (such as Real audio or Window media player, etc.). In accordance with this embodiment of the present invention, one skilled in the art is able to make the control program pro1 as well as contents-providing display file linked to a contents file information database as described in step S31 of FIG. 2.

FIG. 4 illustrates the dynamic production of contents-providing display file. The following components are provided for use with this production: contents-providing display file 20-1, control module pro1 (i.e., WEB/DB linking module) stored in the web server 4 for transmitting and receiving data to/from a browser, a plurality of database(DB) 22-1 and 23-1 where contents URL information and corresponding digital contents files are stored using a storage device (S-HDD) linking the URLs to the contents buttons (icons) of the contents-providing display file, a DB server pro2 (such as DBMS) to support building the contents DB and retrieving the same. Contents-providing means 20-1 provides digital audio Bible contents according to the user desires by operation of the control module. Each contents DB comprises URL information tables of contents files in several languages providing each user with contents in different language for a given script. The processes include following steps.

(1) The step of selecting a database: Reference numerals 22 and 23 indicate menu icons that are linked to the corresponding contents DB 22-1 and 23-1 having the same name provided by display file. When the user clicks on (or selects) the desired menu icon with a mouse, the contents providing display file 20-1 linked to the selected menu icon is displayed on the right frame. FIG. 4 shows the state of contents-providing display file 20-1 providing customized digital audio contents linked to the Bible DB. This information is displayed on the right frame of user browser 20 upon the user pressing the Bible menu icon 22. As a result, control module pro1 receives information indicating that the user has selected the Bible DB 22-1 linked to the contents DB menus in the display file.

(2) The step of selecting contents attribute: In this step, the user selects contents attributes the user desires. The selection is made through a plurality of contents attribute selection means 24 through 27, which enables to vary audio attributes with respect to the same script of the Bible. The attribute selection means can vary audio attributes in language 24, the speed of speech 25, voice type 26 and playback device 27. When selecting attributes, the user clicks on the drop-down buttons 24A, 25A, 26A and/or 27A, and chooses values for the attributes of language, speed, voice and playback device in list boxes 24L, 25L, 26L and 27L.

(3) The step of sending the selected information of the contents attributes: after the user selects ‘English’ in language 24, ‘slow’ in speech speed 25, ‘women’ in voice 26 and ‘mp3 player’ in playing device 27 as in FIG. 4, the user clicks on a search button 20-2 in the display file 20-1 to send the selected information to the control module of the web server.

(4) The step of dynamically producing the contents-providing display file: the control module dynamically produces the display file such as the Bible contents-providing display file 20-1 in which contents buttons are linked with the contents file's URL information corresponding to the contents attribute selection information sent by the user. This display file is displayed on the user's terminal, as illustrated in the following sub-steps:
(a) The step of opening the DB: the control module confirms the attribute selection information of the selected contents while verifying that, for example, ‘The Bible’ is selected in the contents DB, ‘English_Bible in language table, ‘slow’ in speech speed, ‘woman’ in voice, and ‘MP3 player’ in playback device. The Bible DB is opened in this step according to these selections.
(b) The step of linking an audio file is performed through the following steps:
   (b-1) the step of retrieving records of the same attribute: the control module verifies and combines the user selection information to retrieve records having the same attribute from the table of English_Bible 24-1 of FIG. 3 pursuant to classification number and extension name of file, e.g., ‘MP3’ to MP3 player and ‘RAM’ to Real Audio. The ‘classification number’ is marked ‘BESW’ (The Bible-English-Slow-Woman) in consideration of the combination of user attribute selection information as in the table of FIG. 3.
   (b-2) the step of linking the contents button 28 of the display file to the retrieved file name: the contents button 28 of the Bible contents-providing display file 20-1 in FIG. 4 is linked to the URL of the corresponding audio contents file name selected from the group 2 retrieved in the step (b-1). The button is preferably named with the ‘contents name’ of table 24-1 of FIG. 3.
(c) The step of linking script file: the script file is stored in the form of, for example, ‘HTML’ in group 4 as shown in table of FIG. 3. The script button 29 of the Bible contents-providing display file in FIG. 4 is linked to the URL of the corresponding script file name selected from the group 4. Preferably, script button 29 is named with the ‘contents name’ of table 24-1 of FIG. 3. Next, the customized contents-providing display file is dynamically produced and provided to the user. The dotted line between 28 and 28-1, and 29 and 29-1 in FIG. 4 indicates the linkage between contents buttons of the produced contents-providing display file 20-1 and corresponding digital contents files.

As set forth above, control module pro1 retrieves URL information of a contents file according to the user's selection, and producing the display file where the contents buttons (icons) are linked to the corresponding URL information. It is well known to those skilled in the art that the procedure of producing dynamic contents-providing display file can be described in other way as executed by the web server or the central processing unit (CPU) of the server instead of the control module pro1.

Thus far, only one example of a WEB/DB linking module for dynamically producing customized contents-providing display file linked to a database and used as the customized contents-providing means is described. However, the customized contents-providing means may include other types of the WEB/DB linking display file such as board-type display file as described in step S31 of FIG. 2. Moreover, the contents-providing display file described above only link with the URL information of a single file of type ‘RAM’ or ‘MP3’ depending on the attribute selection for the playback device 27 made by the user. Accordingly, it takes a long time to provide the file (MP3) for off-line play upon the user's request for a file having the same attribute (with regarding to language, voice and speed) as that of the on-line file (RAM), because the server must dynamically produce a display file linked to the URL of an off-line file. However, in actual case, it may be desirable that the contents-providing display file has contents-providing buttons for both on-line and off-line files, so the contents-providing display file preferably has buttons for both on-line files and off-line files. Moreover, the searching operation of the control module (i.e., retrieving contents files having the attributes corresponding to user selection) described above should be regarded as one of the preferable embodiments. In a realistic case, the retrieving method of the control module may be varied according to the methods of building the contents file information DB and/or producing the contents-providing display file as is understood by those skilled in the art.

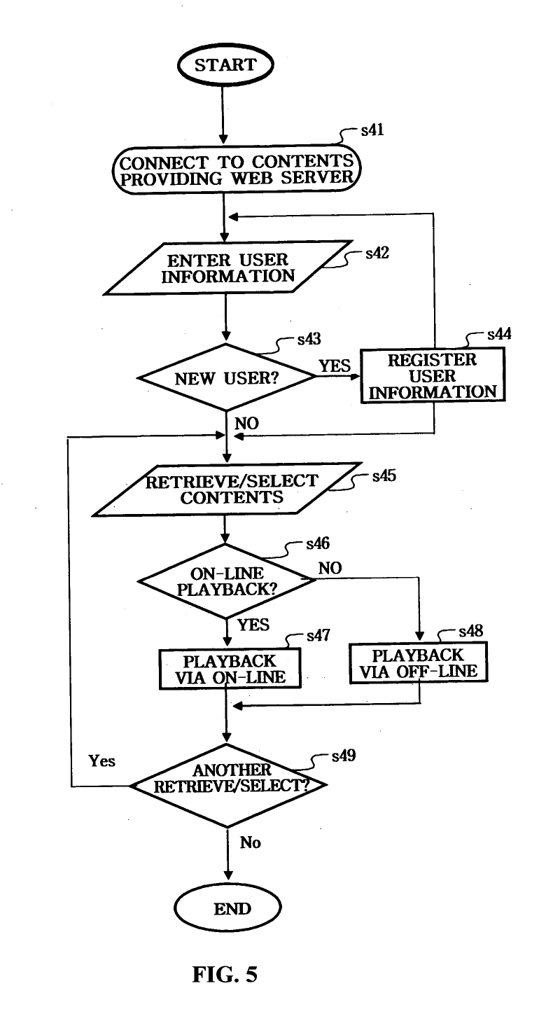

FIG. 5 shows a flow chart illustrating the procedure by which the user uses contents in the web site of the present invention, which is programmed into code executed by a computer and stored in the server's storage device. The user connects to the web site of the contents-providing web server 4 using terminal 1 or 2 equipped with a web browser 20 via wired or wireless Internet 3 (step S41). Upon being connected to the server, the homepage of the web site is downloaded to the user terminal and displayed through the web browser. The user then enters the user information and then log-on by a user information input means in the homepage (step S42). The web server's CPU verifies whether the user information is registered in the User DB 4b-3, and if is, step S45 is executed (step S43). If not, the server registers the user information in the User DB 4b-3 and then either goes back to step S42 to request log-on again or proceeds to step S45 (step S44). When the user enters contents title (such as contents DB name, etc.) and desired contents attribute information as searching keywords into the contents-providing means (display file) of the web site, the CPU retrieves (or dynamically produces) the contents-providing display file corresponding to the user attribute selection information and sends it to the user terminal enabling the user to click on the contents button 28 if desired (step S45). The invention is characterized in that the contents button is linked to one of a plurality of contents which are different from one another in at least one attribute regarding languages, voices, the speech speed, and playback devices. However, although the attributes vary, the meaning of the script associated with the contents is the same. When the contents file linked to the selected contents button 28 is downloaded to the user terminal, the CPU of the terminal determines whether the contents file can be played in streaming mode (step S46). If the downloaded file is an on-line playable file 28-2 such as a ‘RAM’ file, a streaming contents playing program installed on the user terminal (such as Real Audio) is automatically executed to play the streaming file (RA) linked to the RAM file on the server's storage device (step S47). Moreover, if the downloaded file is an off-line playable file such as a ‘MP3’, the contents file is played by a corresponding contents playback program (e.g., WinAmp, etc) installed on the user terminal whenever desired by the user. In this latter case, the contents file may be transferred to portable playback devices such as MP3 players and then played (step S48). In the step S49, the sequence goes back to the step S45 or terminates. Furthermore, the menu in voice type box 26L may list real names of performers instead of terms such as man, woman, old and young described in FIG. 2.

FIG. 5 shows that the invention can provide different on-line or off-line contents having different attributes according to the user's selection. Such attributes relate to the same script, are selectable and include voice and speed of speed. A listener can listen repeatedly to a foreign language learning contents varying attributes according to their level of knowledge. Moreover, this process can also be applied to other languages.

The present invention is characterized by comprising the user attribute selection means 24 through 27 by which the user chooses desired contents with selectable attribute in language (English, Chinese, and Japanese, etc), the speed of speech (normal, slow, and very slow, etc), voice type (man, woman and children, etc), and playback device (on-line or off-line playback) corresponding to the same script according to her/his taste, level, and environments. Accordingly, the users can easily configure the customized learning material (contents) by themselves at lower cost, dynamically and easily.

The contents-providing display file (documents) or contents DB menu pages which function as contents-providing means can be customized by a registered user by the method comprising the following steps of:

(1) building contents use information DB that includes file names of the contents-providing display file which has been provided to the user, contents attributes selected by the user in display file; and registered member number (identifying number). Accordingly, the DB consists of a combination of use information obtained from the contents-providing display file based on the user. The contents use information DB is built by the user choosing and registering specific contents-providing display file using a registering means provided by the server. Examples include a shopping cart function linked with the contents use information DB of the server. When logging off the web site, recently used contents-providing display file use information may be automatically stored (or registered) in the storage device according to the user identifying number. Furthermore, registered information preferably may be automatically removed when the predetermined storage capacity for information is full; and

(2) searching user's contents use information from the contents use information DB when the user logs in the web site and dynamically restoring (producing) the customized contents-providing means (home page) to which the user has recently accessed by combining the use information with a template display file form (which is prepared and stored in the server) linked to WEB/DB linking module. This enables the user to receive the contents that he/she has recently used.

The customized contents-providing means (home page) has a function for recalling the contents having specific attributes that the user received recently when the user logs onto the web site, which brings a lot of convenience regarding the necessity to use the same contents for learning foreign language or music repeatedly. Particularly, such a function is useful for wireless terminals because the wireless terminals are inferior to desktop computers in the size of display, communication rate and input means. The capacity storage for the contents-providing display file use information stored in the contents use information DB is preferably limited to the predetermined value for each user. Also, the registered contents-providing display file use information may be deleted manually by the user.

### THE 2ND EMBODIMENT

A second embodiment of the present invention is directed to a method of building a large quantity of audio contents at low cost. This embodiment directly relates to the fourth object of the invention set forth above. Audio contents having several user selectable attributes corresponding to the same script of contents are usually expense. Two methods are provided to solve the above problem.

In one method, users produce and upload the audio contents on a warehouse-board of the web site. Users that provide contents in this manner may be paid by the service provider or rewarded in some other way. The method may be performed as follows:

(1) The web site provides a user-produced contents registering means. The user producing contents registering means includes a means for providing a user with the contents information to be registered; contents producing tools in program; and a means for uploading the produced contents, e.g., a warehouse-board. The contents information to be registered includes the corresponding contents-providing display file and the script to be recorded for the contents-providing display file; contents attribute information such as language, voice and speed of speech; and the information for the method in which to produce contents.

(2) The user confirms the contents to be registered, searches and receives the contents-providing display file that provides the script file. Next, the user records the script using recording device to make an audio contents file. If necessary, the audio contents file is encoded into digital files with a program (such as a contents producing tool). The user-produced contents is then uploaded on the predetermined ware-house of the web site. At this time, the user may download contents producing tools for encoding and editing contents from the web site if needed. Preferably, when uploading the audio contents file, the attribute information of the file and personal information of the provider are registered.

The text of corresponding printed book can be used as the script for sound recording of this embodiment instead of the script file provided by the server.

(3) The uploaded audio contents file is then verified by the website administrator. If necessary, the audio contents file is amended using suitable contents producing tools to conform with the requirements of the contents-providing display file. The audio contents files are stored in the related contents DB to be linked to the corresponding display file.

In another method, the customized contents DB may be built by cooperation of the branch web sites in various countries, as follows:

(1) Main web site playing a central role is prepared. The main website provides contents for learning foreign languages or music available to users all over the world. Although, digital audio contents DB is mainly provided in English, a determination is made whether contents of other languages should be provided and made available. In this step, no particular language is preferred.

(2) The main website is used to collect local companies located in various countries. Each local company builds a local branch website using the present invention such that a contents DB in each native language is built. Each contents DB includes contents corresponding in meaning to the English-version built by the main site. The contents of the main website as well as contents of other branch websites are made available by suitable selection of contents attributes 24 through 27 in FIG. 1b. Furthermore, a local branch builds its own language contents DB in languages of both the branch's country and English, thereby providing users with selection means via display file.

(3) The main site links the contents DB in various native languages to the user selection means to provide the user with contents in various languages according to a user selection. Also, each local branch site links the contents in various languages to its contents-providing display file or receives the contents-providing display file linked to the contents in various languages from the main website to append to its own site.

The method of this embodiment (technology) enables production of various and sufficient contents in various languages at low cost wherein each branch configures the customized contents-providing system while only producing contents in its own language. Preferably, local sites make the homepage interface (menu) pages in English as to be able to use the original display file sent from the main site. The user is then provided with customized contents in various languages through any of the local sites. In the above case, it is desirable that the users register their membership information in each country's sites as required by the appropriate service fee. Finally, certification of user between the sites may be performed through site address information, etc., recorded in a cookie received from the site the user logs in.

### THE 3RD EMBODIMENT

In a third embodiment, the invention is applied to music field, enabling the user to learn foreign languages through songs and chants with ease in an enjoyable manner. For example, if a person can sing a certain hymn in Korean, he is able to easily learn the corresponding hymn in other languages of the musical note and song words. Furthermore, a user may effectively learn songs as well as recite song words in foreign languages if provided with the audio contents and the corresponding musical notes and song words files in various languages, according to customized method of the present invention via Internet.

The method of this embodiment comprises the steps of:

(1) Building a music contents DB consisting of a plurality of music document files (which includes the files of musical notes and song words) in various languages, and a plurality of corresponding music audio files including chant files to be played in an on-line or off-line mode produced by recording different performances of the music document files by many prayers and various performance means such as musical instruments or voices.

The chant files are produced by performing the ‘song words’ with only the rhythm and beat of a musical note, without the melody of a musical note, with various voices with/without accompanying musical instruments, and recording it into on-line or off-line playable digital audio file formats, wherein, the chant is preferably performed by the professional. The ‘song words’ include the rhythm without a melody, which, in short, comprises a rhythm and a beat with the length of the musical notes (without the melody of the musical note). Song words or sentences such as fairy tales can be performed like a song by adopting the characteristic of a song with respect to rhythm and beat as is described in a master's thesis entitled ‘Teaching Listening and Speaking through Song and Chant’, Yun-Ah, KIM, a graduate school of education in Seoul National University of Education, 2001. 2.

(2) Linking the music contents DB to the musical contents-providing display file using the technology set forth above in FIG. 4. The contents-providing means (display file) may have a user attribute selection means for the musical performance type replaced with a voice attribute selection means 26 in FIG. 1b. The selectable musical attributes for performance type attribute selection means includes vocal music with or without accompanying musical instruments, piano music, orchestra music, etc., and/or a chant in compliance with the score. The produced audio files (musical files and chant files) are linked to the corresponding selectable list of the musical performance type.

(3) Providing users with the customized music contents through the music contents-providing display file.

The configuration of the system in the present embodiment is the same as that of the customized language-learning contents-providing system set forth above. In summary, the customized music contents can also be provided through the same system.

Characteristic of the present embodiment may be appreciated by the following procedures conducted by a user:

(1) The user logs onto the web site (homepage) and selects the music contents-providing means (display file);

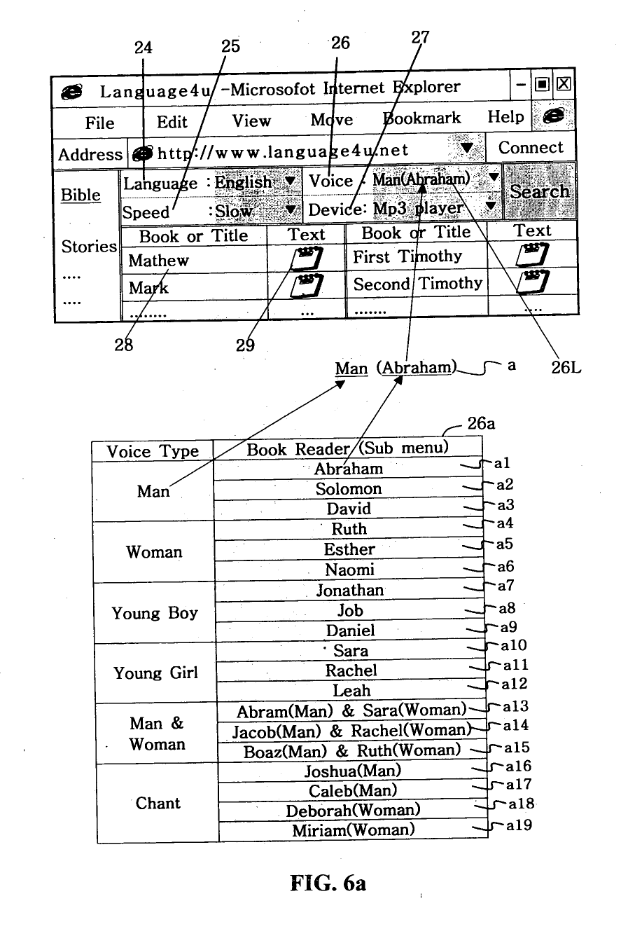

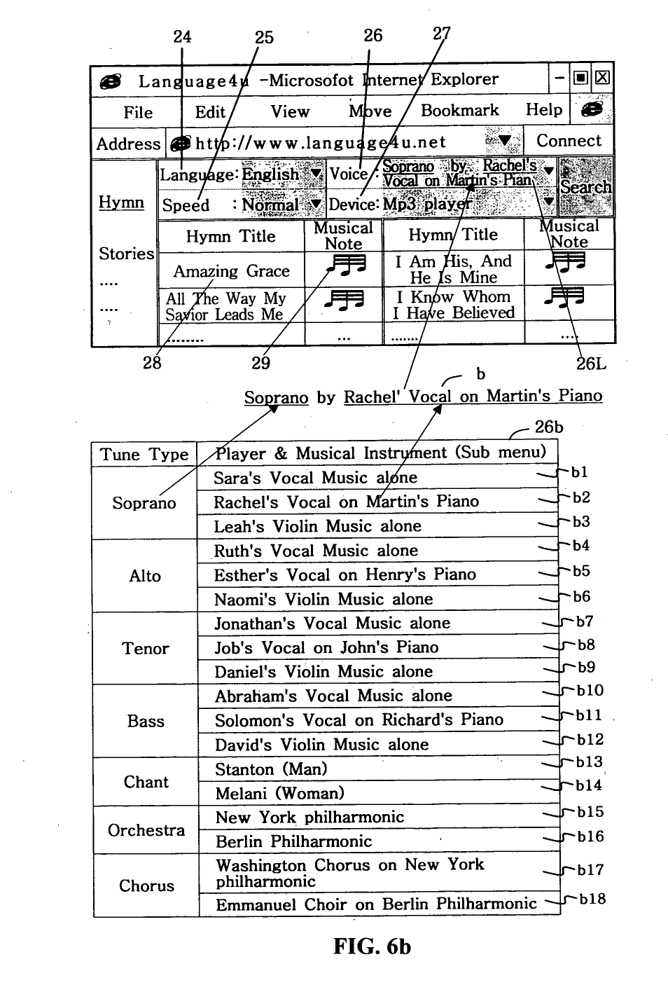

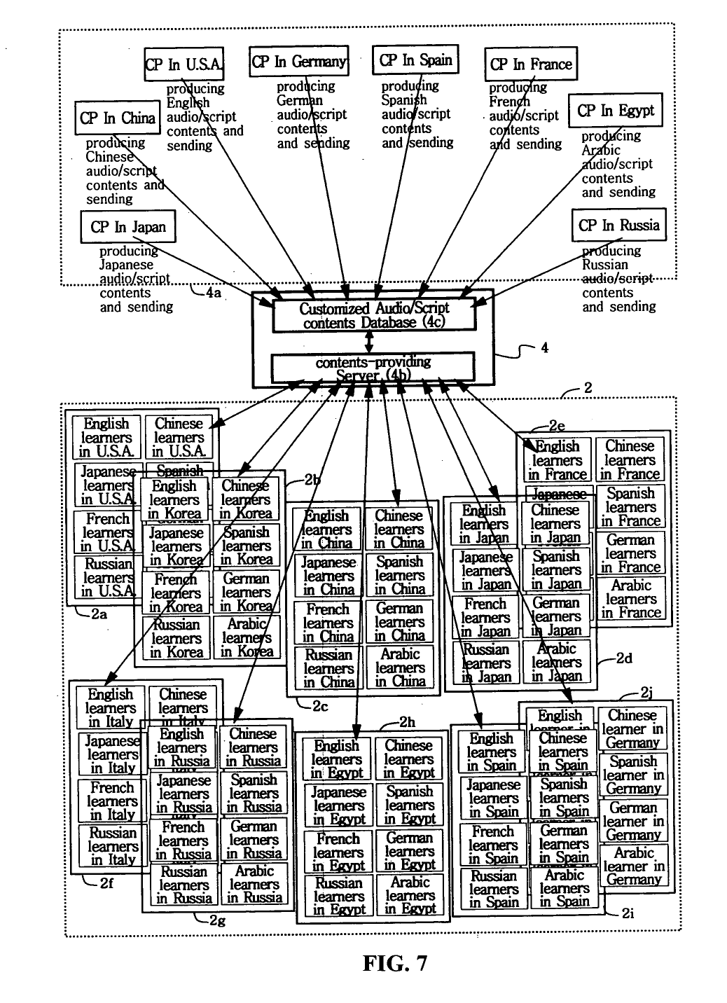

(2) The user selects English in language attribute selection means 24 and vocal music in musical performance type selection means of the music contents-providing means (display file) like FIG. 6b for learning a well known hymn in English which corresponds to a Korean version. The user is thereby provided with the corresponding music contents-providing display file from the server. Next, the user clicks on the script button for the musical note to be popped up in a separate window. The user listens to the vocal music of the selected song by clicking on the contents button as desired.

In other way, the process can be programmed such that the musical note is automatically displayed as the user clicks on the related audio content button;

(3) The user can not listen to and/or understand the words of the song, for he/she is unfamiliar with the English hymn and unable to follow the playback speed; and

(4) Therefore, the user switches the performance type into a chant performed with mainly song words of the same musical note. The user tries listening to and following the chant several times while looking at the script of the musical note and/or song words by selecting the desired contents buttons. As a result, the user can be familiarized with the song words and rhythm of the musical note, which enables the user to enjoy vocal music according to the above steps.

The present embodiment is not limited to the situations set forth above. For example, members of different groups of a chorus should repeatedly practice a specific section. Therefore, a person playing a piano or the like typically must repeat the same song for each group. Members of each group that are practicing must wait their turns because of being unable to practice with the piano prayer. The present invention solves such problems by providing the selection for the performance type which includes vocal music such as alto, soprano, bass, tenor or the like, and various musical instrument music in the music contents-providing web page. Therefore, an individual or a group can practice a song and/or a chant at any place and at any time in on-line or off-line mode according to user's desire.

FIG. 6a and FIG. 6b illustrate a specific use of the present invention in language learning and music learning respectively.

As illustrated in FIG. 6a, the Book reader information of audio files that link to voice contents buttons 28 of foreign language learning contents providing means (display file) of FIG. 1b are preferably built into a database like 26a so as to be linked to voice attribute selection means 26 and for user 2 to select preferred Book reader classified according to voice type such as man, woman, young boy, young girl, chant and the like.

Man (Abraham) a as a selected attribute illustrates the displaying format of the voice attribute selected by user 2 in the selectable attribute list 26L of voice attribute selection means 26.

the book readers for each voice(sound) recording may be one or more according to the contents of the script book, each playing a designated character like a radio drama; the voice(sound) recording includes background music; and the way of reading book includes many ways such as chant, storytelling and the like so that learners 2 can change audio attributes, to attract listener's attention and interest, therefore provide a good listening effect.

As illustrated in FIG. 6b, the prayer & Musical instrument information of audio files that link to music contents buttons 28 of music learning contents providing means (display file) of FIG. 1b are preferably built into a database like 26b so as to be linked to voice attribute selection means 26 and for user 2 to select preferred prayer & Musical instrument classified according to music tune type such as soprano, alto, tenor, bass, chant, orchestra, chorus and the like.

Soprano by Rachel's vocal on Martin's piano b as a selected attribute illustrates the displaying format of the musical performance type attribute selected by user 2 in the selectable attribute list 26L of voice attribute selection means 26.

Using the present invention in music field, user 2 can select and listen to different music at each repetition time varying attributes different from each others in prayer, accompanying music, musical instrument and/or the like classified by tune type.

For that reason, there may be a plurality of selectable different musical performance type attributes such as Sara's vocal music alone b1, Rachel's vocal music on Martin's piano music b2 and Leah's violin music alone b3 even in a soprano tune alone.

Numerals b1-b18 illustrate different music files that user 2 can select and be provided with, at each repetition time, varying musical performance type attributes classified by tune type such as soprano, alto, tenor, bass, chorus, orchestra, chant and the like in the present invention.

It may be preferable that the playback speed attribute of the playback speed attribute selection means 25 of FIG. 1b fixes to Normal state except when playing chant, and the caption of voice attribute selection means 26 is changed to Music instead of Voice in case of providing music contents using the present invention.

FIG. 7 illustrates a practical example of above mentioned audio contents producing means 4a of the present invention, more specifically the method to produce and provide users with a plurality of contents easily and cheaply.

Wherein contents providers (CP) 4a located in many countries produce and send to main web site (main server) 4 each country's language version audio contents and/or script contents equivalent to other country's language version contents according to contract with server owner 4 using the above mentioned audio contents producing technology of the present invention, while foreign language learners located in each country can be provided with all kinds of contents server 4 can provide.

For example, though CP in Japan produces and provides only Japanese version audio and/or script contents, foreign language learners 2d in Japan can be provided with all language versions of contents server 4 provides. Moreover learners 2b in Korea just as learners in Japan also can be provided with all language versions of contents server 4 provides even if the server 4 do not provide Korean version contents.

Wherein CP 4a may be individual, company, publishing company or oversea branch company using the present invention and as disclosed in the second embodiment, includes a local native language learner located in many countries.

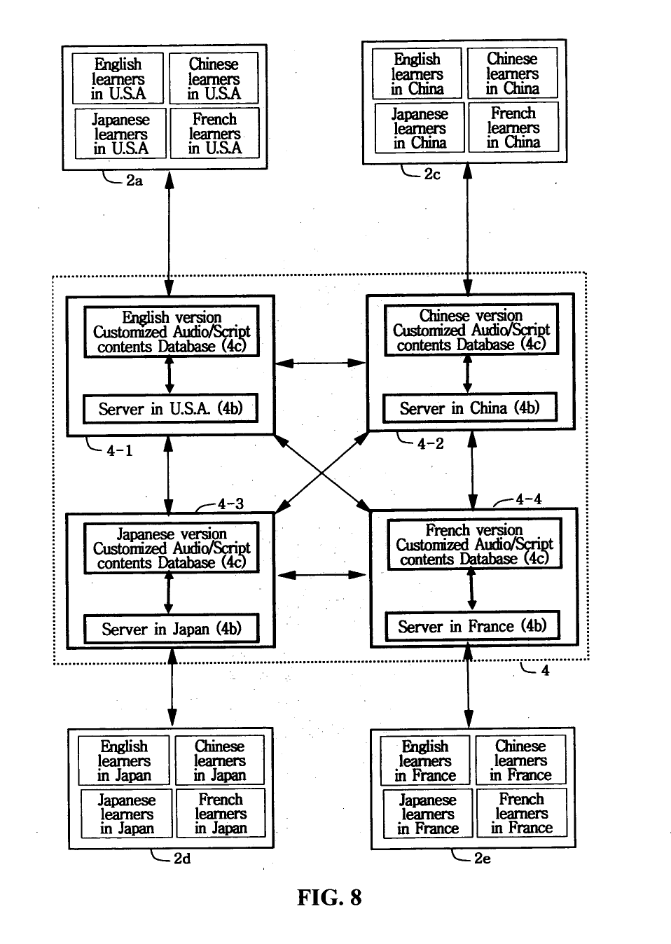

FIG. 8 illustrates an practical example using branch servers described in the second embodiment of the present invention, more specifically the method of data link between branch servers 4-1, 4-2, 4-3 and 4-4, and the system configuration for that method. Wherein each branch server using the present invention located worldwide only produces each country language version contents but can provide each users with other language version contents equivalent in meaning to each country language version contents through data link between branch servers.

For example server 4-3 in Japan may build only Japanese version customized audio and/or script contents database 4c but language learners 2d in Japan can be provided with not only Japanese version but also English, Chinese and French version contents through data link between branch server 4-1, 4-2, 4-3 and 4-4.

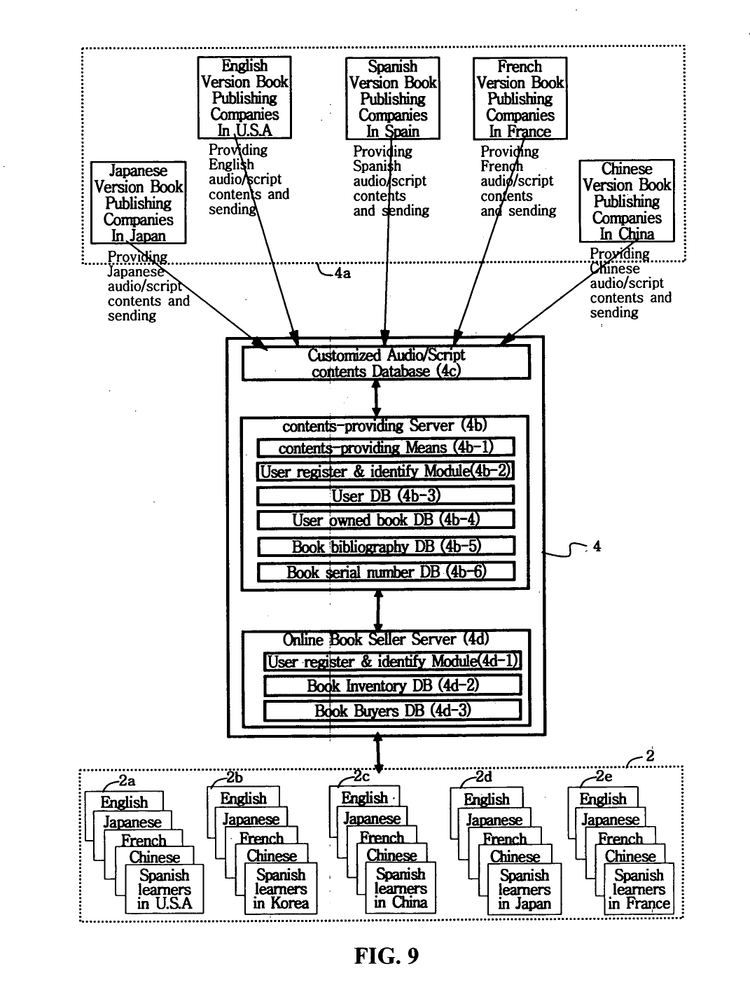

FIG. 9-FIG. 13 illustrate the method to produce customized audio contents for the present invention through publishing companies 4a located worldwide wherein each publishing company executes the function of above mentioned audio contents producing means 4a and CP as in FIG. 7.

The characteristics of this practical example is in that using the present invention each publishing company can produce only each country language version audio and/or script digital contents using a selected hard copy (printed) book in each language published by each company as a script and provide to server 4, but foreign language learners using each language version printed book for text book located in each country can be provided with all language version digital audio contents just as in other practical examples of the present invention described above.

In the conventional technology, Compact Disc (CD) or audio tape containing voice (audio) version of printed (hard copy) book as a script is sold together with the script (printed) book as a package goods in language learning field (especially in foreign language learning text book publishing field) but they are no good for foreigners to be used for language learning because the voice reading speed may be too fast for foreigners to catch up with even if the sentences are well known to the learners and the reading speed is normal by native's standard. Moreover they should listen to only one kind voice and/or one kind reading speed contents even at repetition times, so they can be easily bored with repeatedly listening to one kind voice and/or one kind speed voice, besides, can not train listening to many voices.

This embodiment of the present invention is to solve the problem of the conventional technology above mentioned, wherein each publishing company produces and stores on server 4 instead of CD or audio tape the customized audio contents having a plurality of different attribute digital audio files each corresponding to a same printed version script (book) using the present invention described above, and when selling a printed book, only provides a coupon like the form of Book serial number 34a with which to be provided with digital audio version of the purchased printed book through server 4, not providing CD or audio tape as in the conventional art. Through which learner 2 can be conveniently provided with audio contents having selectable audio attributes according to learner's request using audio attribute user selection means 24 through 27 of FIG. 1b, and publishing company can sell better goods (book) having coupon for being provided with customized digital audio contents from server 4, and server 4 can gather more good audio and/or script contents easily and cheaply.

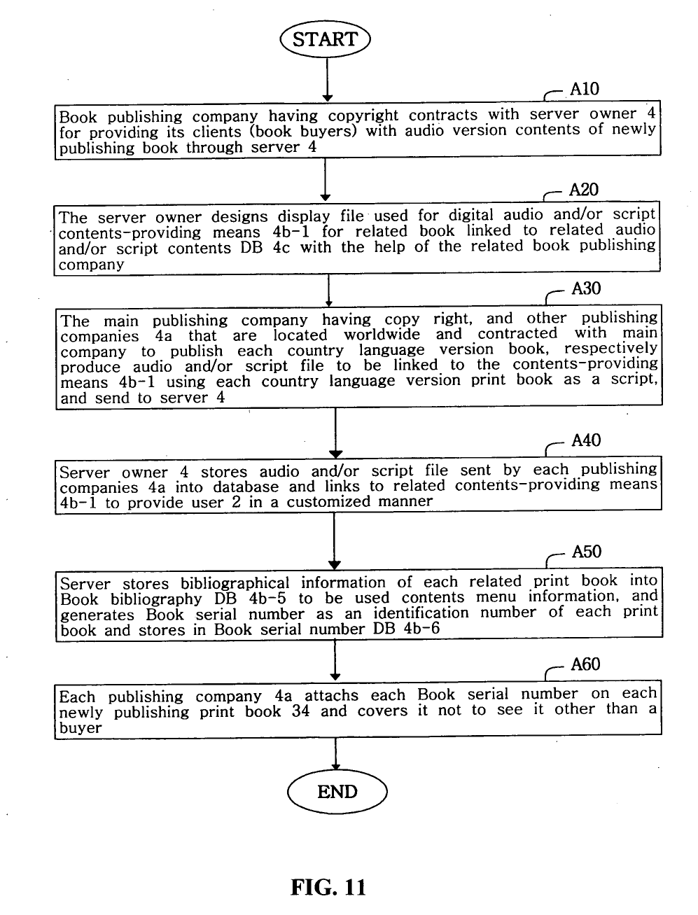

FIG. 11 illustrates the process of gathering many kinds of audio contents from publishing companies and building contents database (DB) to provide related book buyers (users) with customized audio contents, comprising as following steps:

book publishing company having copyright contracts with server owner 4 for providing its clients (book buyers) with audio version contents of newly publishing book through server 4 (STEP A10);

the server owner designs display file used for digital audio and/or script contents providing means 4b-1 for related book linked to related audio and/or script contents DB 4c with the help of the related book publishing company (STEP A20);

the main publishing company having copy right, and other publishing companies 4a that are located worldwide and contracted with main company to publish each country language version book, respectively produce audio and/or script file to be linked to the contents providing means 4b-1 using each country language version printed book as a script, and send to server 4 (STEP A30);

server owner 4 stores audio and/or script file sent by each publishing companies 4a into database and links to related contents providing means 4b-1 to provide user 2 in a customized manner (STEP A40);

server stores bibliographical information of each related printed book into Book bibliography DB 4b-5 to be used contents menu information, and generates Book serial number as an identification number of each printed book based on a designated rule and stores it in Book serial number DB 4b-6 (STEP A50); and

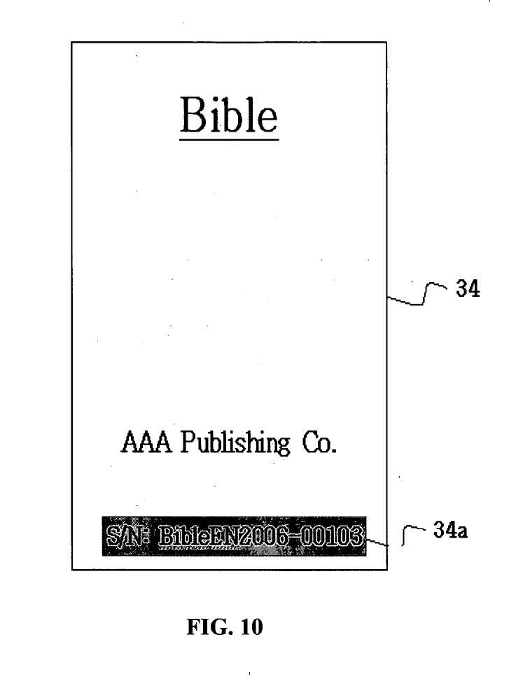

each publishing company 4a attaches each Book serial number like 34a of FIG. 10 on each newly publishing printed book 34 sold and covers it not to see it other than a buyer (STEP A60).

A receipt number or other corresponding numbers in the form of on-line or off-line coupon issued by a book publishing company or a book store when selling a printed script book may be used for identifying the book buyer linked with the identified information of the book buyer, the book seller and/or the book publishing company, which are registered in User owned book DB 4b-4, instead of the Book serial number 34a provided by off-line manner or on-line manner like an on-line book store seller server 4d. For which purpose the server owner 4 and the book seller 31 or the book publishing company make contract and each server of the contractors comprises means of sharing the identification information of the coupon and/or the book buyer through networking each others.

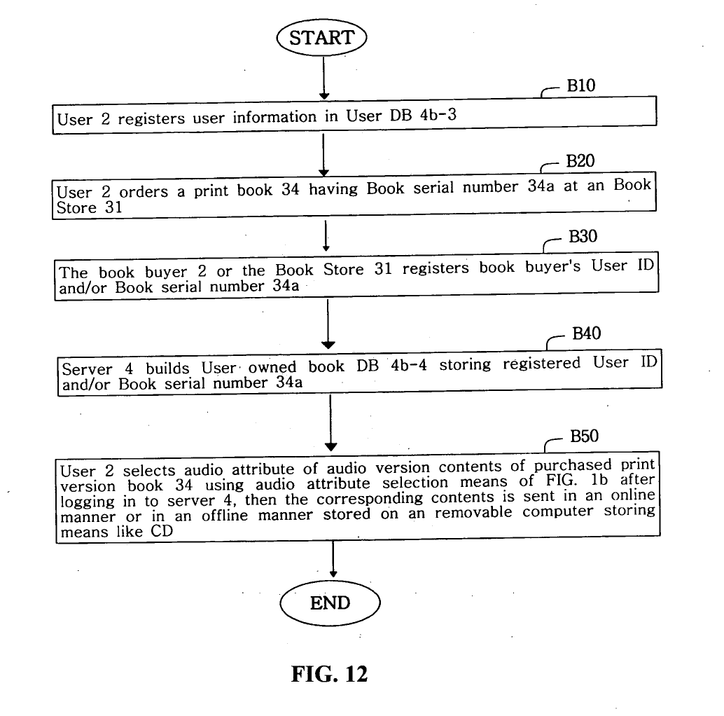

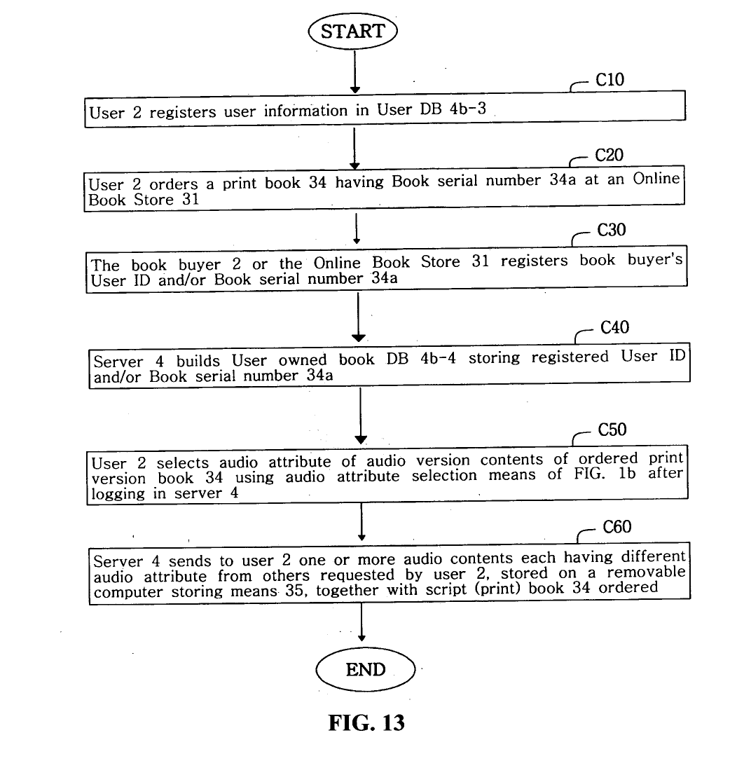

FIG. 12 illustrates the process that user 2 buys a book 34 having Book serial number 34a as an book identification number and is provided with audio contents from database built in the manner as in FIG. 11, comprising as following steps:

user 2 registers user information in User DB 4b-3 through User register & identify Module 4b-2 of server 4 (STEP B10);

user 2 buys a printed book 34 having Book serial number 34a at a book store 31 (STEP B20); said book store 31 including not only offline book stores but also online book stores like Book seller server 4d as illustrated in FIG. 9.

the book buyer as user 2 or the book store 31 registers book buyer's User ID and Book serial number 34a (STEP B30);

server 4 builds User owned book DB 4b-4 storing registered User ID and Book serial number 34a linked with User DB 4b-3 and Book bibliography DB 4b-5 (STEP B40); and

user 2 selects at least one audio attribute of audio version contents of purchased printed version book 34 using audio attribute selection means 24 through 27 of FIG. 1b after logging in server 4, then the corresponding contents is sent in an online manner or in an offline manner stored on a removable computer storage means like CD (STEP B50).

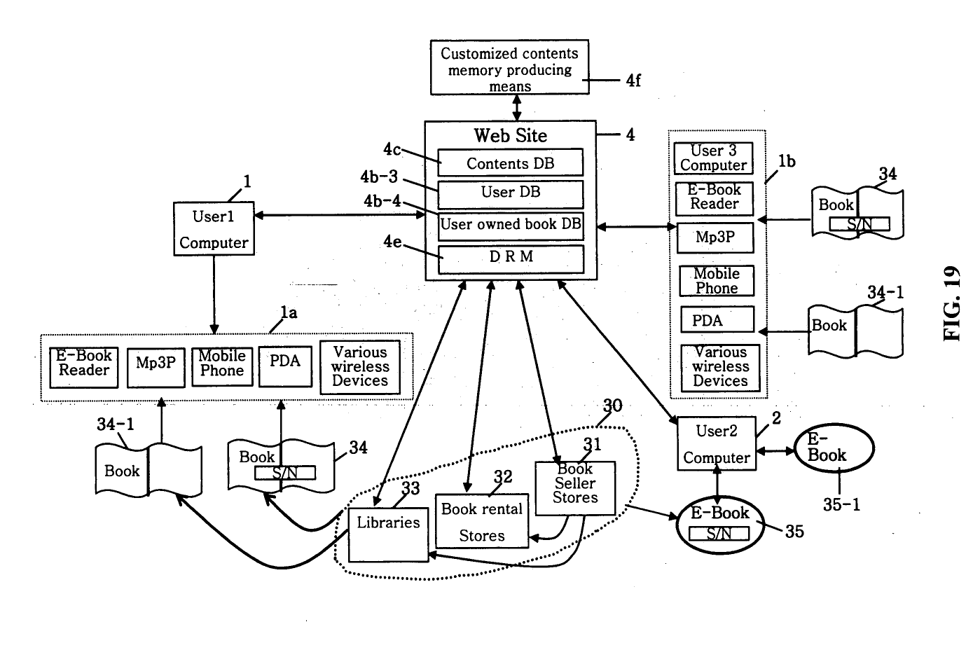

FIG. 13 illustrates the process that user 2 select at least one of audio files each having different audio attribute from others but equivalent to the same script when ordering a printed book at an online book store like 4d of FIG. 9 and/or 31 of FIG. 19; and server 4 writes the corresponding contents on a removable computer storage means such CD, DVD, flash memory and the like using customized contents memory producing means like 4f of FIG. 19, and sending it together with the related printed book ordered. This process, compared with the process of FIG. 12, is the same except the fact of ordering book in online mode in STEP C20, and the fact of sending to user 2 at least one of a plurality of audio contents each having different audio attribute from others requested by user 2, stored on a removable computer storage means 35 or 35-1, together with the related printed book 34 ordered through book supply network such as book seller stores 31 in STEP C60, especially this embodiment is useful for a user located where high rate computer communication network is not widely supplied.

user 2 registers user information in User DB 4b-3 through User register & identify Module 4b-2 of server 4 (STEP C10);

user 2 orders a printed book 34 having Book serial number 34a at an Online Book Store 31 such as Online Book Seller Server 4d of FIG. 9 (STEP C20);

the book buyer as a user 2 or the Online Book Store 31 registers book buyer's User ID and/or Book serial number 34a (STEP C30);

server 4 builds User owner book DB 4b-4 storing registered User ID and/or Book serial number 34a, linked with User DB 4b-3 and Book bibliography DB 4b-5 respectively (STEP C40);

user 2 selects at least one audio attribute of audio version contents of the ordered printed version book 34 using audio attribute selection means 24 through 27 of FIG. 1b after logging in server 4 (STEP C50); and

server 4 sends to the user 2 at least one of a plurality of audio contents each having different audio attribute from others requested by user 2, stored on a removable computer storage means 35 or 35-1, together with the related script (printed) book 34 ordered through book supply network such as book seller stores 31 (STEP C60).

Basic configuration for this embodiment is the same as that of FIG. 7 but FIG. 9 illustrates additional elements to the system of FIG. 7, comprising:

User owned book DB 4b-4 storing data for identifying a purchased printed book (or a printed book buyer) linked with User ID;

Book bibliography DB 4b-5;

Book serial number DB 4b-6; and

Online Book Seller Server 4d as means for receiving purchasing order via online mode associated with the embodiment of FIG. 13.

These additional elements will be described more specifically in the 4th embodiment below.

It may be understood by those skilled in the art that server owner who using the present invention can produce a plurality of audio and/or script contents more easily and cheaply, and foreign language learners 2 located worldwide can be provided with many kinds of audio and/or script contents cheaply, and additionally can organize in a customized manner by themselves and can be provided with contents for language learning and/or musical learning tailored to learner's language, level, environment and interest.

Preferably the script contents provided by server 4 only may be bibliographical information, abstract or part of the whole book to promote selling of printed books.

Moreover the free use of contents allowed for owner of the printed book 34 may be limited to some period or amount.

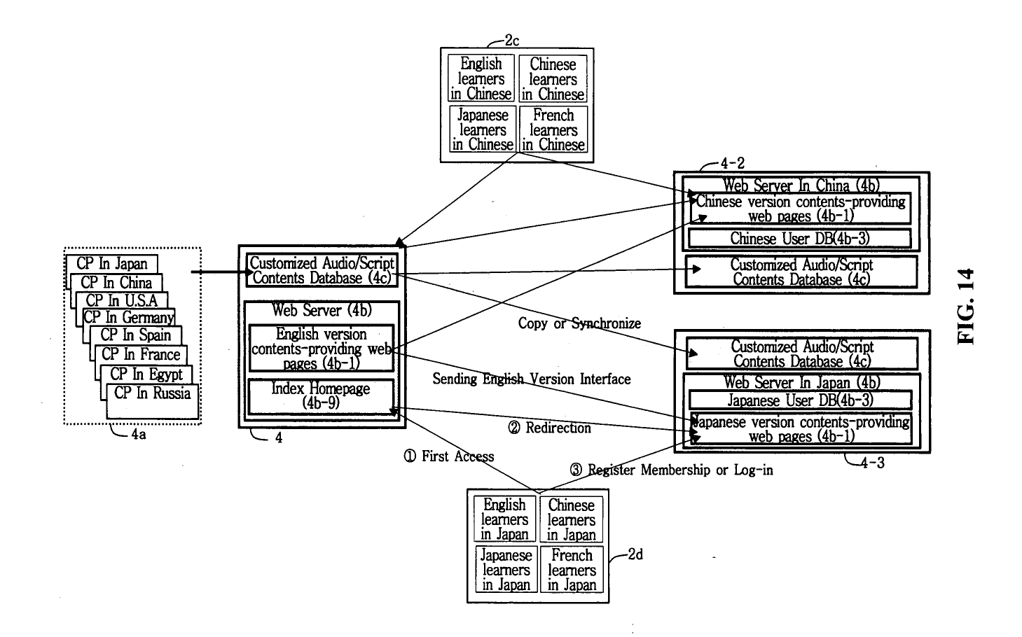

FIG. 14 is to illustrate and describe the way to provide to related local learners 2c or 2d a customized audio contents produced by CP 4a located worldwide through a related local branch server 4-2 or 4-3.

The characteristics of this embodiment is to install many servers like 4-2 and 4-3 based on region or country through which foreign language learners 2 can be provided with contents in a customized manner according to user attribute selection in language attribute, voice attribute, reading speed attribute and/or playback device attribute corresponding to a same meaning script, therefore this embodiment not only can decentralize network traffic to many servers that can provide same contents, but also can provide each country's language version contents providing means(display file), and client service customized to each country.

The basic elements and method for branch server configuration based on region or country comprising:

1) contents DB 4c: by building exactly same one as one of main server through copying or synchronizing audio and/or script contents of main server 4;

2) contents providing means (display file) 4b-1: by translating English version one received from main server 4 into each country's language version one;

3) user's connecting to branch server: by directly connecting to each country's branch server 4-2 or 4-3 like \textcircled{3}, or first access to the index homepage of main server 4 then connecting registered branch server in redirection way like the trace of \textcircled{1} and \textcircled{2};

4) membership registration and login: using User DB 4b-3 of each country's branch server 4-2 or 4-3.

Although there is in FIGS. 8 and 14 illustrated only one server per each branch web site but in actual case each branch web site can comprise many servers for various purpose such as decentralizing network traffic using various conventional technologies like CDN (Contents Delivery Network).

### THE 4TH EMBODIMENT

The 4th embodiment provides the technology of providing a user 2 with customized audio contents produced through various practical embodiment of the present invention in connection with many book rental agencies, more specifically this embodiment actualizes the following scenario:

(a) user 2 Hong, Gil Dong having User ID 550505-1233117 is a student of Seoul National University (SNU) which has contracted with the server owner 4 of the present invention to provide to its students audio version contents of the printed books 34 rented at the university library 33 in a customized way according to user audio attribute selection via online mode through the server 4 of the present invention;

(b) the user Hong rented an English version Bible 34 published in the year 2006 at SNU library 33 for summer vacation, and as soon as connected to and logged in server 4, automatically (or after selecting personal homepage menu) received audio contents providing means(display file) 4b-1 associated with rented printed book 34;

(3) Hong has made much progress in listening ability during summer vacation, for he would repeatedly listen to audio version of the rented printed version English Bible 34 interestingly and effectively without bored with repeatedly listening to same version contents because of availability of varying audio attributes in voice, reading speed and/or playback device at every connecting time to server 4 according to his selection using the audio attribute selection means of FIG. 1b, sometimes reading the associated printed version book at the same time.

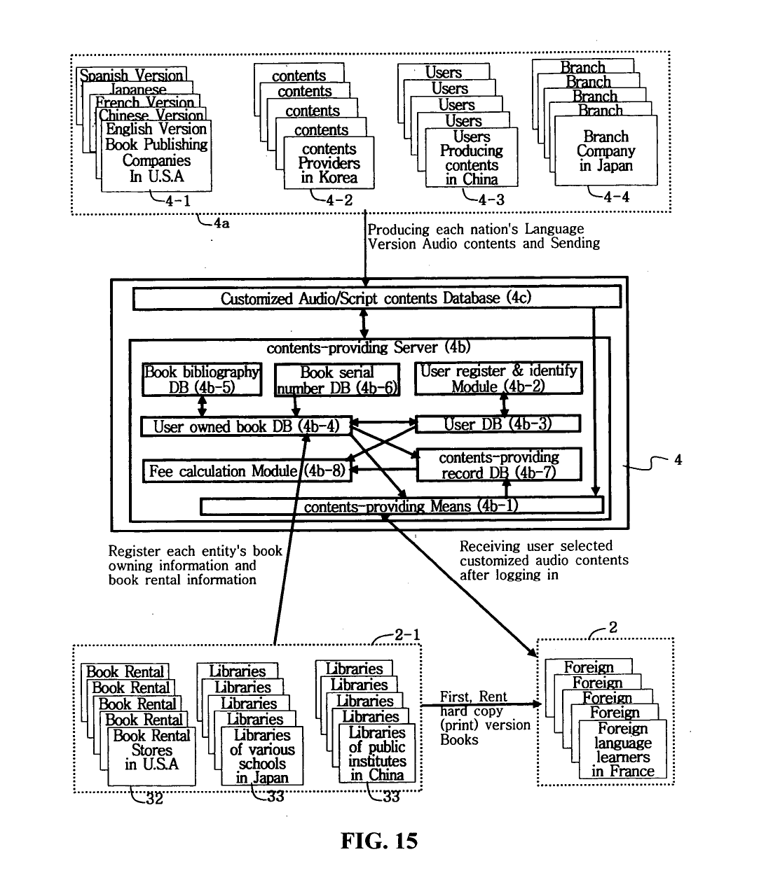

FIG. 15 illustrates a whole system configuration to actualize above scenario, and for that reason, comprises additional elements to the system of FIG. 7 such as DBs 4b-4, 4b-5, 4b-6 and 4b-7 that are needed for providing even book renters (borrowers) 2 with audio versions of the printed books and computer program 4b-8 linked with these DBs.

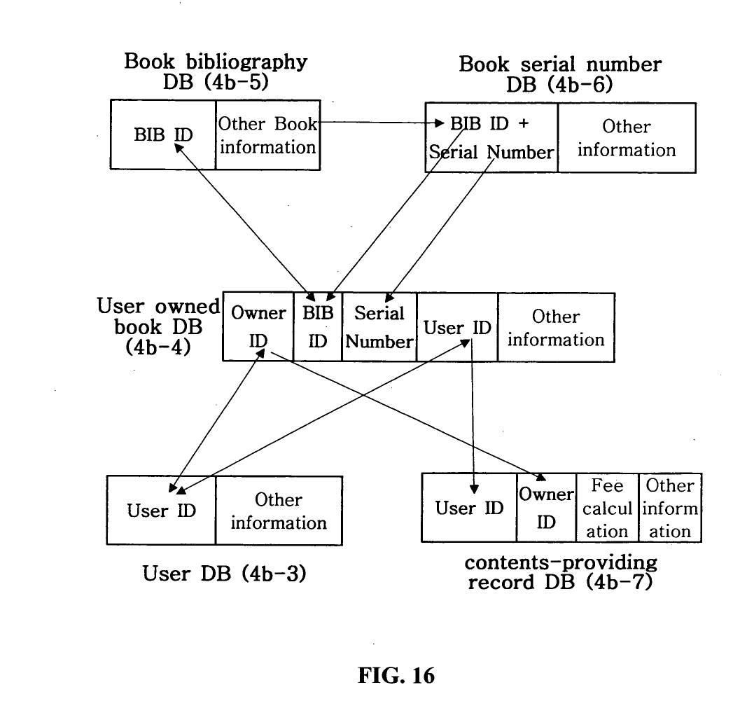

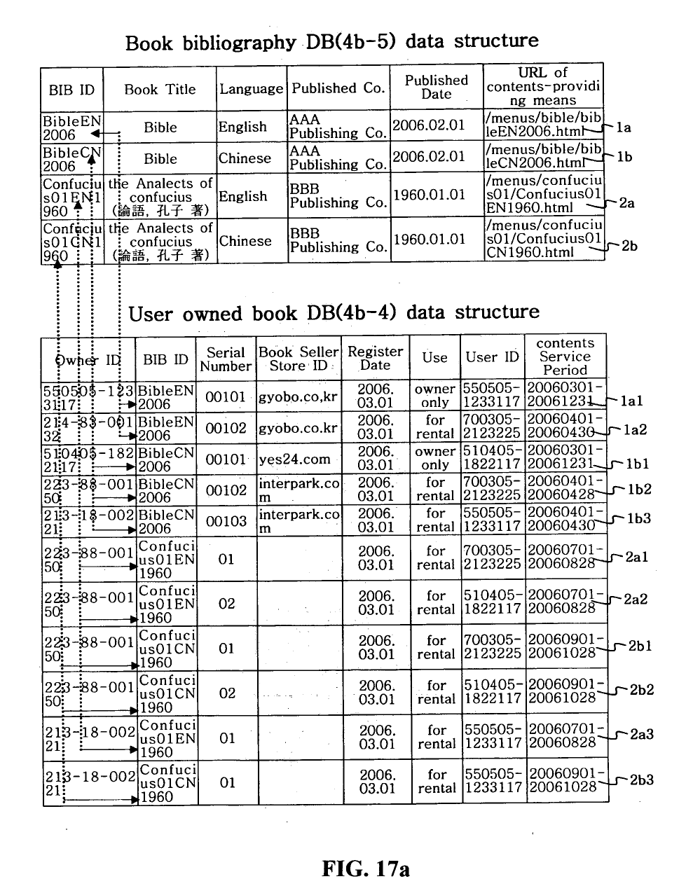

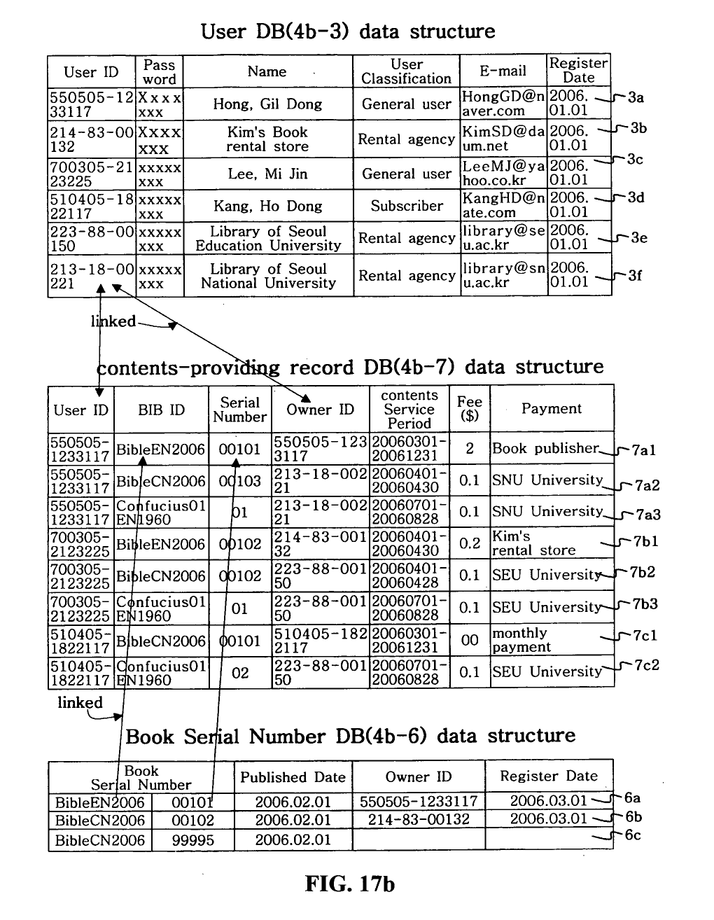

FIG. 16 illustrates data link and relation between DBs of FIG. 15, FIG. 17a and FIG. 17b wherein:

Book bibliography DB 4b-5 stores bibliographical information of printed (script) version book for providing digital audio version, is also used for menu information for audio version book provided by server 4, and is linked with User owned book DB 4b-4 and Book serial number DB 4b-6 using BIB ID as key field, the BIB ID may be ISBN (International Standard Book Number);

Book serial number DB 4b-6 also relates to the practical use of the embodiment illustrated in FIG. 9, is used for identifying a printed book 34 sold on condition of providing customized audio contents to the learner 2 (purchaser of the book) through server 4 of the present invention, comprising at least the field of Book serial number which consists of BIB ID plus Serial Number allocated to a newly publishing book in covered state like numeral 34a of FIG. 10 so as to be read by only a purchaser when registering to server 4 to be used for identification of the book, and is linked with Book bibliography DB 4b-5 and User owned book DB 4b-4;

User owned book DB 4b-4 stores information to identify a book owner and/or a renter (borrower) 2 for providing customized audio contents of the printed book 34, has data fields consisting of at least Owner ID, BIB ID, Serial Number, User ID and other related information, and is linked with Book serial number DB 4b-6 using Book serial number as key field, with Book bibliography DB 4b-5 using BIB ID as key field, with User DB 4b-3 and with Contents providing record DB 4b-7 using Owner ID and/or User ID as key fields;

User DB 4b-3 stores information to identify a user, as is widely used in conventional electronic commerce system, has data fields consisting of at least User ID, User Classification, and is linked with User owned book DB 4b-4 using User ID as Key field;

Contents providing record DB 4b-7 is to record history information regarding server's providing audio contents to users 2 has data fields consisting of at least User ID, Owner ID and contents providing related information, is mainly used to calculate service fee that is charged to book owner and/or user 2 through Fee calculation Module 4b-8.

FIG. 17a and FIG. 17b illustrate specific data structures described above briefly wherein:

Book bibliography DB 4b-5 comprises, as data fields, BIB ID mainly used for key field, Book Title, Language, Publishing Co., Published Date and URL information of customized audio contents providing means (web page) 4b-1 for this printed book, though not illustrated in PIG, preferably more comprising category information for classification and category base searching, and above mentioned customized audio contents providing means 4b-1 is preferably designed to be able to provide many language versions associated with same meaning scripts server 4 provides as in FIG. 1b;

User owned book DB 4b-4 has at least following data fields:

(a) Owner ID: used for identifying an owner of a printed book, preferably storing the same data as User ID of User DB 4b-3;

(b) BIB and Serial Number: combined together, used for identifying a printed book by server 4, Serial Numbers stored in data records 1a1, 1a2, 1b1, 1b2 and 1b3 are same as those of Book serial Number DB 4b-6, and generated at the step A50 of FIG. 11, and the book information stored in data records 2a1, 2a2, 2b1, 2b2, 2a3 and 2b3 indicates that the books have been published before the use of the present invention, therefore Serial Numbers are not registered in Book serial number DB 4b-6 but generated automatically by server 4 in sequential way based on combination of Book owner ID and BIB ID to be used as an identifier of each printed book;

(c) Book Seller Store ID: used for identifying a book store 31 of FIG. 19 that sells printed books 34, registers Book serial Number 34a and client User ID when selling the book to prevent illegal registration or double registration of Book Serial Number 34a;

(d) Use: used for distinguishing use of a printed book like personal use or rental use;

(e) User ID: storing user identification information for each audio version contents providing corresponding to a printed version book, preferably being User ID of User DB 4b-3 in consideration of linking with other DBs, and registered by rental agency 2-1 when renting to the user 2 of FIG. 15 if the printed book is rented one;

(f) Register Date: The Date of designating a book owner mainly used for checking starting date of providing audio version contents by server 4;

(g) Contents service Period: storing service period of providing audio contents for each User ID, preferably the period is set by a related book publishing company or server 4 in case that the printed book 34 is sold on condition of providing audio contents through the server 4, set by a related book rental agency 2-1 in case of rented book, and set by server 4 in case that the user 2 registered in User ID field is a subscriber user or a general user;

User DB 4b-3 may comprise data fields of User ID, Password, Name, User Classification and Register Date:

the User ID may be a social code number like Hong Gil Dong's User ID 550505-1233117 if user is a person, or may be a tax code number like 214-18-00221 of SNU if user is a company, as is widely used for user identification for internet based electronic commerce system in Korea;

the Register Date is the date when a user 2 was registered in server 4 as a member and is different from Register Date of Book serial number DB 4b-6 or User owner book DB 4b-4 that is the date of designating the owner of each printed book;

and the User Classification mainly relates to calculate service fee and can be classified as follows:

(a) general user: mainly including an owner of coupon like Book serial number 34a for audio contents provided without fee on condition of purchasing a printed book 34, a user of paying a meter-rate base fee and a user of rental book associated with audio contents of the present invention;

(b) rental agency: a printed book rental agency 2-1 including a profit one 32 and a nonprofit one 33, the service fee for providing audio version contents of a rented printed version book preferably is paid by user 2 and/or related rental agency 2-1, and the rental agency may include an individual book owner;

(c) subscriber: a user of paying a fixed base fee for a determined period like a year or a month who can be provided with a part or whole of audio contents server 4 provides according to contract;

Contents providing record DB 4b-7 comprises the data fields of audio contents providing history part like User ID, BIB ID, Serial Number, Owner ID and Contents Service Period, and fee calculating and charging part like Fee and Payment wherein Payment stores fee payers who are decided according to stored data of fields of User Classification of User DB 4b-3, Use of User owned book DB 4b-4 and/or to contract term between the server owner and each publishing company 4a, book rental agency 2-1, and/or user 2;

Book serial number DB 4b-6 comprises the data fields of book serial number part consisting of BIB ID plus Serial Number, and book owner part consisting of Owner ID and Register Date wherein:

(a) Owner ID: used for criteria about whether to register a book owner or to deny registering illegal (or double) registration in User owned book DB 4b-4, for which in records 6a and 6b of FIG. 17b are already registered user identification numbers as User ID, but in record 6c is not registered corresponding data;

(b) Register Date: the date of Owner ID registration mainly used for checking the starting date of providing audio version contents for related printed version book.

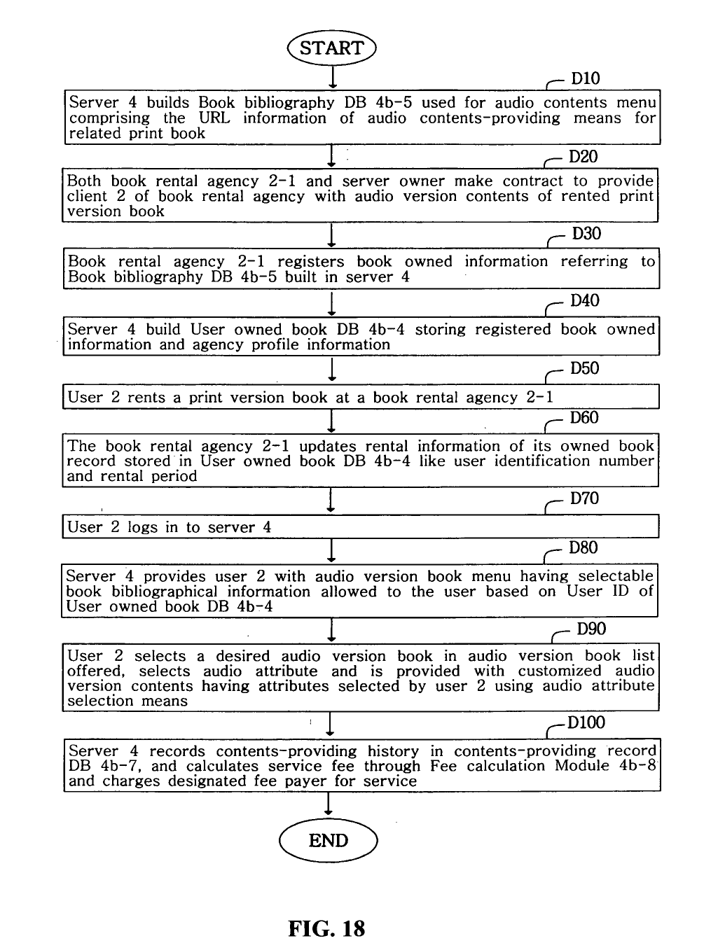

FIG. 18 illustrates the whole operation process of the 4th embodiment consisting of following steps:

the server 4 builds Book bibliography DB 4b-5 used for audio contents menu comprising the URL information of audio contents providing means (display file) for related printed book (STEP D10);

both a book rental agency 2-1 and the server owner 4 make contract to provide client(user) 2 of the book rental agency with audio version contents of rented printed version book (STEP D20);

the book rental agency 2-1 registers book owned information referring to Book bibliography DB 4b-5 built in server 4 (STEP D30);

the server 4 build User owned book DB 4b-4 storing the registered book owned information (STEP D40);

a user 2 rents a printed version book at a book rental agency 2-1 (STEP D50);

the book rental agency 2-1 updates the rental information of its owned book record stored in User owned book DB 4b-4 like user identification number and rental period (STEP D60);

the user 2 logs in to server 4 (STEP D70);

the server 4 provides the user 2 with an audio version book list having selectable book bibliographical information allowed to the user based on user identification number like User ID of User owned book DB 4b-4 (STEP D80);

the user 2 selects a desired audio version book in the audio version book list offered, selects audio attribute and is provided with customized audio version contents having attributes selected by the user 2 using audio attribute selection means 24 through 27 of FIG. 1b (STEP D90);

the server 4 records contents providing history in Contents providing record DB 4b-7, and after some period of time, calculates service fee through Fee calculation Module 4b-8 and charges designated fee payer for service (STEP D100).

In spite of many practical examples associated with FIGS. 9-18, if the user 2 pays for service fee against his/her provided audio contents, without mediation of a rental agency 2-1 or a printed book store 31 for registering related information to server 4, the user 2 may be directly provided with audio version contents of any kind printed book like a rental book, a newly purchased book and/or an old book, with or without coupon if the server 4 has built associated customized audio version contents DB of the present invention.

FIG. 19 illustrates a system using various practical examples of the present invention, so for the configuration of a specific embodiment, one or more elements may be added or omitted on the basis of the system of FIG. 19, wherein:

numerals 34-1 and 35-1 indicate that the user 2 of a fixed base fee or a meter-rate base fee can be provided with audio version contents for a printed version book without a coupon like Book serial number 34a;

numeral 30 illustrates a supply network of printed version books 34 having Book serial number 34a as a coupon wherein numeral 31 indicates an online or offline book store, numeral 32 and 33 indicate book rental agencies renting to users 2 printed books purchased at a book store 31; numeral 1a indicates many kinds of mobile audio contents playback devices which can store audio contents received from the server 4 through the computer 1 and playback it with or without user's reading the related printed book 34 or 34-1;

numeral 1b illustrates many kinds of audio contents playback devices each of which has a wire or wireless communication function to connect server 4 so as to download audio contents directly and playback it with or without user's reading the related printed book 34 or 34-1;

numeral 2 indicates that user can use movable memory means like CD storing audio version contents (E-BOOK) produced through customized contents memory producing means 4f in computer 2;

numeral 4e indicates the use of conventional DRM (Digital Right Management) to limit the service period of legal user 2 or to prevent illegal copy and/or illegal use of contents provided by the server 4 if needed.

As set forth above, the present invention by which contents for learning foreign language or music is produced and provided by a server has advantages as follows:

1. Educational audio contents corresponding to the script contents can be customized with ease and effectiveness according to user's desire and preferences regarding language, voice, speed of speech, musical performance type or listening environment.

2. The user can repeatedly listen to the contents with respect to the same script varying audio attributes regarding languages, voices, speeds of speech or the like at any place and at any time, facilitating the improvement of recitation of script, listening and pronunciation, etc., according to the invention.

3. The voices of common native speakers can be commercialized as a high value thereby making mass production of foreign language-learning audio material (contents) possible. Also, it is possible to decrease the cost of contents production because various language-version contents can be produced by native speakers, contents providers, book publishing companies and/or branch websites in a number of countries. As a result, the user can have access to various contents for learning foreign language or music at a low expense.

4. Since the user can receive the customized language-learning and/or musical learning contents in various languages at the same site, the user can learn various foreign languages and/or music with ease, fun and convenience.

5. Not only a book buyer can be conveniently provided with customized digital audio contents tailored to the buyer's request, but also a book publishing company can sell better goods (book) having coupon for being provided with customized digital audio contents.

6. Even conventional book rental agencies can give their clients not only conventional book rental service but also customized audio book rental service tailored to client's request at a low cost and in a easy way.

The present invention has been described in detail. However, it should be understood that the detailed description and specific examples (which indicate preferred embodiments of the invention) are given by way of illustration only, since various changes and modifications within the spirit and scope of the invention will become apparent to those skilled in the art from this detailed description.

### INDUSTRIAL APPLICABILITY

The present invention may be used in the musical learning field as well as other language-learning fields to produce and provide customized digital audio contents with a low cost in a facile manner as set forth above.

1. A system for providing customized contents, comprising a contents database and a contents-providing server connected to a wired or wireless communication network,
the contents database comprising digital contents for language learning or musical learning, each contents comprising:
a plurality of digital audio files each associated with an equivalent script, the plurality of digital audio files being characterized by one or more audio attributes such that each audio file of the plurality of audio files differ in at least one audio attribute from other digital audio files associated with the equivalent script wherein the audio attributes include a playback device attribute and at least one attribute selected from the group consisting of a musical performance type attribute, a language attribute, a voice attribute and a playback speed attribute; and
the server operable to:
receive user selected audio file attribute selection information;
retrieve an audio file corresponding to the received information from the database; and
provide the retrieved audio file to the user.

2. The system of claim 1, wherein the digital audio files are linked by a contents-providing means, the contents-providing means comprising:
a GUI-based display file or text-based display file having at least one audio file linking menu and an audio attribute selection means that includes a component selected from the group consisting of a language attribute selection means, a voice attribute selection means, a playback speed attribute selection means, a musical performance type attribute selection means and a playback device attribute selection means.

3. The system of claim 2, wherein the contents-providing means includes a musical performance type attribute selection means wherein the scripts are various musical notes, the audio files of each contents are files made by recording various musical performances per each equivalent musical note.

4. The system of claim 1, wherein the contents is provided from users, local branch contents-providing servers, contents providers or book publishing companies located in a plurality of countries.

5. The system of claim 2, wherein the server further comprises a user-produced contents register, the user-produced contents register operable to:
provide the user with contents information to be registered;
up-load user-produced contents; and
store up-loaded contents in a contents database.

6. The system of claim 1, wherein the contents-providing server comprising:
a main contents-providing server and one or more local branch contents-providing servers located in one or more countries,
each branch server is linked with the main serve or other branch servers and able to access the contents of the main server or other branch servers and optionally build a contents database in each native language corresponding in meaning to the contents of the main server or other branch servers wherein the local branch servers are operable to build contents databases that are accessible to the main server or other branch servers.

7. A method for providing customized contents with a system comprising a contents database and a contents-providing server connected to a wired or wireless communication network,
the contents database comprising digital contents for language learning or musical learning, each contents comprising:
a plurality of digital audio files each associated with an equivalent script, the plurality of digital audio files being characterized by one or more audio attributes such that each audio file of the plurality of audio files differ in at least one audio attribute from other digital audio files associated with the equivalent script wherein the audio attributes include a playback device attribute and at least one attribute selected from the group consisting of a musical performance type attribute, a language attribute, a voice attribute and a playback speed attribute; and
the method comprising:
(a) providing a user terminal with user selectable contents menu information having an audio file attribute selection means;
(b) receiving user selected audio file attribute information through the user terminal; and
(c) retrieving an audio file corresponding to the received audio file attribute information from the database, and providing the retrieved audio file to the user terminal.

8. The method of claim 7, wherein the digital audio files are linked by a contents-providing means, the contents-providing means comprising:
a GUI-based display file or text-based display file having at least one audio file linking menu and an audio attribute selection means that includes a component selected from the group consisting of a language attribute selection means, a voice attribute selection means, a playback speed attribute selection means, a musical performance type attribute selection means and a playback device attribute selection means.

9. The method of claim 8, wherein the contents-providing means includes a musical performance type attribute selection means wherein the scripts are various musical notes, the audio files of each contents are files made by recording various musical performances per each equivalent musical note.

10. The method of claim 7, wherein the contents is provided from users, local branch contents-providing servers, contents providers or book publishing companies located in a plurality of countries.

11. The method of claim 8 further comprising the step of registering user-produced contents, the user-produced contents registering step comprising:
providing the user with the information of the contents to be registered;
up-loading the user-produced contents; and
storing up the up-loaded contents in a contents database.

12. The method of claim 7, wherein the contents-providing server comprises:
a main contents-providing server and one or more local branch contents-providing servers located in one or more countries,
each branch server is linked with the main serve or other branch servers and able to access the contents of the main server or other branch servers and optionally build a contents database in each native language corresponding in meaning to the contents of the main server or other branch servers wherein the local branch servers are operable to build contents databases that are accessible to the main server or other branch servers.

13. A system for providing customized contents connected to a wired or wireless communication network, comprising a contents-providing server, a contents DB, a user DB, a book bibliography DB and a user owned book DB,
the contents DB comprising digital contents for language learning or musical learning, each contents comprising:
a plurality of digital audio files each associated with an equivalent script, the plurality of digital audio files being characterized by one or more audio attributes such that each audio file of the plurality of audio files differ in at least one audio attribute from other digital audio files associated with the equivalent script wherein the audio attributes include a playback device attribute and at least one attribute selected from the group consisting of a musical performance type attribute, a language attribute, a voice attribute and a playback speed attribute;
the user DB comprising information to identify a user;
the book bibliography DB comprising bibliography information of script version book of digital audio version;
the user owned book DB comprising information to identify an owner or a user of each script book for providing digital audio version of the script version book in a customized way; and
the server operable to:
(a) receive an information for identifying a user of a script book;
(b) identify the user of specific script book;
(c) provide the identified user with contents menu information for audio version of the script book having an audio file attribute selection means for the audio version;
(d) receive selected information for audio file and its audio attribute of the audio version from the identified user;
(e) retrieve the audio file corresponding to the received audio file attribute information from the contents DB; and
(f) provide the retrieved audio file to the user via online or offline.

14. The system of claim 13, further comprising a book serial number DB comprising book identification numbers each allocated to a script book respectively for identification for providing its digital audio version.

15. The system of claim 14, wherein the information for identifying a user of a script book is a script book serial number, a receipt number issued by a book seller or a book publishing company, user identification information, an identification information of a book seller or a book publishing company, or some of theses all.

16. The system of claim 13, wherein the information for identifying an owner or a user of a script book in the user owned book DB is registered by the book owner or a book store of the script book.

17. The system of claim 13, wherein the way of providing the retrieved audio file corresponding to the received audio file attribute includes the way that the server sends to the user one or more audio version contents each having different audio attribute from others stored on a removable computer storage means, if ordered by the user, together with the script book.

18. The system of claim 13, wherein the audio files stored on the contents DB are provided from users, local branch contents-providing servers, contents providers or book publishing companies located in a plurality of countries.

19. The system of claim 13, wherein the user of a script book is a book owner or a book borrower registered in the User owned book DB as the user of the rented book by the book owner.

20. The system of claim 13, wherein the service fee for providing digital audio version is charged to the book publishing company of the script book, the script book owner or the script book borrower, or some of these all for partial charge.

21. A method for providing customized contents with a system comprising a contents-providing server, a contents DB, a user DB, a book bibliography DB and a user owned book DB connected to a wired or wireless communication network,
the contents DB comprising digital contents for language learning or musical learning, each contents comprising:
a plurality of digital audio files each associated with an equivalent script, the plurality of digital audio files being characterized by one or more audio attributes such that each audio file of the plurality of audio files differ in at least one audio attribute from other digital audio files associated with the equivalent script wherein the audio attributes include a playback device attribute and at least one attribute selected from the group consisting of a musical performance type attribute, a language attribute, a voice attribute and a playback speed attribute;
the user DB comprising information to identify a user;
the book bibliography DB comprising bibliography information of script version book of digital audio version;
the user owned book DB comprising information to identify an owner or a user of each script book for providing digital audio version of the script version book in a customized way; and
the method comprising:
(a) receiving an information for identifying a user of a script book;
(b) identifying the user of specific script book;
(c) providing the identified user with contents menu information for audio version of the script book having an audio file attribute selection means for the audio version;
(d) receiving selected information for audio file and its audio attribute of the audio version from the identified user;
(e) retrieving the audio file corresponding to the received sleeted audio file attribute information from the contents DB; and
(f) providing the retrieved audio file to the user via online or offline.

22. The method of claim 21, wherein the system further comprising a book serial number DB comprising book identification numbers each allocated to a script book respectively for identification for providing its digital audio version.

23. The method of claim 22, wherein the information for identifying a user of a script book is a script book serial number, a receipt number issued by a book seller or a book publishing company, user identification information, an identification information of a book seller or a book publishing company, or some of theses all.

24. The method of claim 21, wherein the information for identifying an owner or a user of a script book in the user owned book DB is registered by the book owner or a book store of the script book.

25. The method of claim 21, wherein the way of providing the retrieved audio file corresponding to the received audio file attribute includes the way that the server sends to the user one or more audio version contents each having different audio attribute from others stored on a removable computer storage means, if ordered by the user, together with the script book.

26. The method of claim 21, wherein the audio files stored on the contents DB are provided from users, local branch contents-providing servers, contents providers or book publishing companies located in a plurality of countries.

27. The method of claim 21, wherein the user of a script book is a book owner or a book borrower registered in the User owned book DB as the user of the rented book by the book owner.

28. The method of claim 21, wherein the service fee for providing digital audio version is charged to the book publishing company of the script book, the script book owner or the script book borrower, or some of these all for partial charge.
